(19) United States
(12) Patent Application Publication
(10) Pub. No.: US 2024/0121043 A1
(43) Pub. Date: Apr. 11, 2024

(54) SRS TD-OCC CONFIGURATIONS

(71) Applicant: QUALCOMM Incorporated, San Diego, CA (US)

(72) Inventors: Mostafa KHOSHNEVISAN, San Diego, CA (US); Muhammad Sayed Khairy ABDELGHAFFAR, San Jose, CA (US); Yitao CHEN, San Diego, CA (US)

(21) Appl. No.: 18/353,034

(22) Filed: Jul. 14, 2023

Related U.S. Application Data
(60) Provisional application No. 63/377,711, filed on Sep. 29, 2022.
(60) Provisional application No. 63/377,704, filed on Sep. 29, 2022.

(51) Int. Cl. H04L 5/00; H04L 27/26

(52) U.S. Cl. CPC H04L 5/0048; H04L 27/26035

(57) ABSTRACT

Apparatus, methods, and computer program products for wireless communication are provided. An example method may include receiving a configuration indicating for the UE to apply one or more time domain orthogonal cover code (TD-OCC) sequences across multiple sounding reference signal (SRS) ports. The example method may further include transmitting SRS on each of the multiple SRS ports with the one or more TD-OCC sequence according to the configuration.

### CROSS REFERENCE TO RELATED APPLICATION(S)

This application claims the benefit of and priority to U.S. Provisional Application Ser. No. 63/377,404, entitled “SRS TD-OCC CONFIGURATIONS” and filed on Sep. 29, 2022, and U.S. Provisional Application Ser. No. 63/377,711, entitled “SRS DROPPING WITH TD-OCC” and filed on Sep. 29, 2022, each of which is expressly incorporated by reference herein in its entirety.

### TECHNICAL FIELD

The present disclosure relates generally to communication systems, and more particularly, to wireless communication systems with time domain orthogonal cover code (TD-OCC) sequences.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. The at least one processor may be configured to receive a configuration indicating for the UE to apply one or more time domain orthogonal cover code (TD-OCC) sequences across multiple sounding reference signal (SRS) ports. The at least one processor may be configured to transmit SRS on each of the multiple SRS ports with the one or more TD-OCC sequence according to the configuration. The apparatus may include at least one memory and at least one processor coupled to the at least one memory. The at least one processor may be configured to drop one or more symbols of a set of symbols for a sounding reference signal (SRS) transmission having a time domain orthogonal cover code (TD-OCC), the SRS transmission including a cyclic shift and a comb offset. The at least one processor may be configured to determine to drop or transmit remaining symbols of the SRS transmission.

In another aspect of the disclosure, a method, a computer-readable medium, and an apparatus at a network node are provided. The apparatus may include at least one memory and at least one processor coupled to the at least one memory. The at least one processor may be configured to output a configuration indicating for a UE to apply one or more TD-OCC sequences across multiple SRS ports. The at least one processor may be configured to receive SRS on each of the multiple SRS ports with the one or more TD-OCC sequence according to the configuration. The at least one processor may be configured to configure a UE with an SRS resource for an SRS transmission having a TD-OCC. The at least one processor may be configured to provide an indication for the UE to drop or transmit remaining symbols of the SRS transmission in response to dropping one or more symbols of the SRS transmission.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of comb spacing and comb offset.

FIG. 5A is a diagram illustrating an example of frequency hopping and repetition.

FIG. 5B is a diagram illustrating an example of frequency hopping and repetition.

FIG. 5C is a diagram illustrating an example of frequency hopping and repetition.

FIG. 6 is a diagram illustrating an example of multiplexing of different SRS ports.

FIG. 7 is a diagram illustrating example communications between a network entity and a UE.

FIG. 8 is a diagram illustrating example port index, cyclic shift, and comb offset.

FIG. 9 is a diagram illustrating example communications between a network entity and UEs.

FIG. 10A is a diagram illustrating an example of dropping SRS symbol.

FIG. 10B is a diagram illustrating an example of dropping SRS symbol.

FIG. 11A is a diagram illustrating an example of dropping SRS symbol.

FIG. 11B is a diagram illustrating an example of dropping SRS symbol.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Some aspects provided herein provide different configurations or UE capability with regard to whether TD-OCC is used across different UEs, or across different ports of the same UE (same SRS resource) and rules regarding number of unique TD-OCC sequences that can be configured for a SRS resource with P ports. For the case that TD-OCC is applied for SRS transmission of the same SRS resource at different SRS ports, aspects provided herein may provide mechanisms for the UE and base station to determine a cyclic shift and/or comb offset based on whether SRS ports apply the same TD-OCC sequence or different TD-OCC sequences. Aspects provided herein may provide efficient mechanisms for dropping SRS symbols in SRS for TD-OCC. In some aspects, dropping may not be used for all UEs. In some aspects, instead of dropping, a UE may change some of the SRS parameters to mitigate the interference and still transmit the remaining symbols. Some aspects provided herein may allow network with flexibility to control the behavior for different SRS resources or different UEs in various scenarios.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

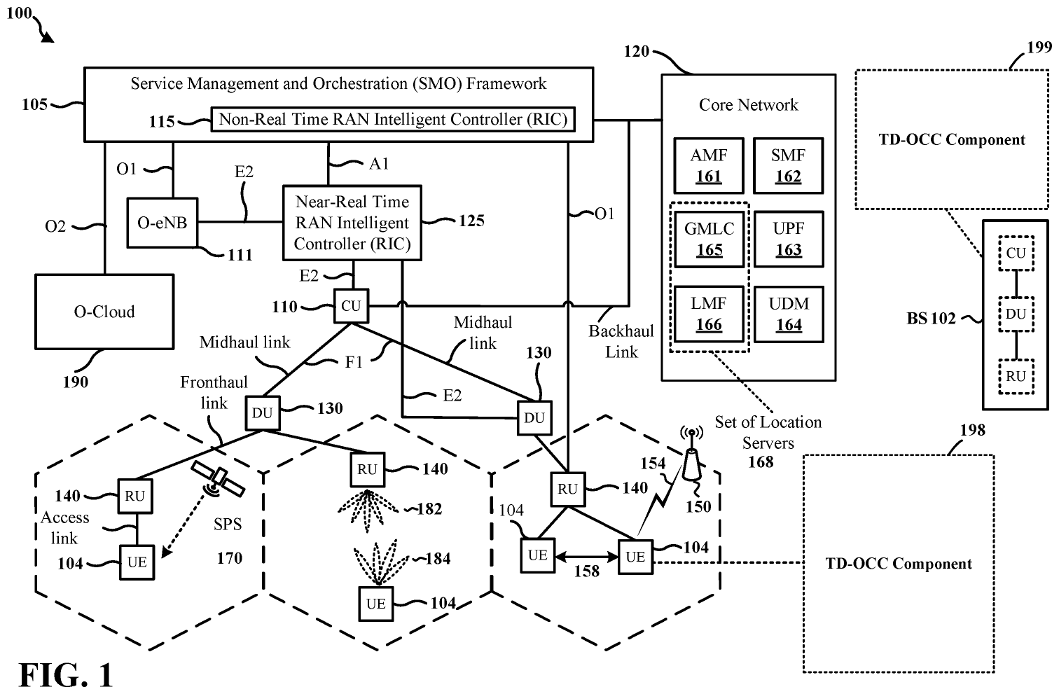

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a TD-OCC component 198. In some aspects, the TD-OCC component 198 may be configured to receive a configuration indicating for the UE to apply one or more TD-OCC sequences across multiple SRS ports. In some aspects, the TD-OCC component 198 may be further configured to receive a configuration indicating for the UE to apply one or more TD-OCC sequences across multiple SRS ports. In some aspects, the TD-OCC component 198 may be configured to drop one or more symbols of a set of symbols for an SRS transmission having a TD-OCC, the SRS transmission including a cyclic shift and a comb offset. In some aspects, the TD-OCC component 198 may be further configured to determine to drop or transmit remaining symbols of the SRS transmission.

In certain aspects, the base station 102 may include a TD-OCC component 199. In some aspects, the TD-OCC component 199 may be configured to output a configuration indicating for a UE to apply one or more TD-OCC sequences across multiple SRS ports. In some aspects, the TD-OCC component 199 may be further configured to receive SRS on each of the multiple SRS ports with the one or more TD-OCC sequence according to the configuration. In some aspects, the TD-OCC component 199 may be configured to configure a UE with an SRS resource for an SRS transmission having a TD-OCC. In some aspects, the TD-OCC component 199 may be further configured to provide an indication for the UE to drop or transmit remaining symbols of the SRS transmission in response to dropping one or more symbols of the SRS transmission.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

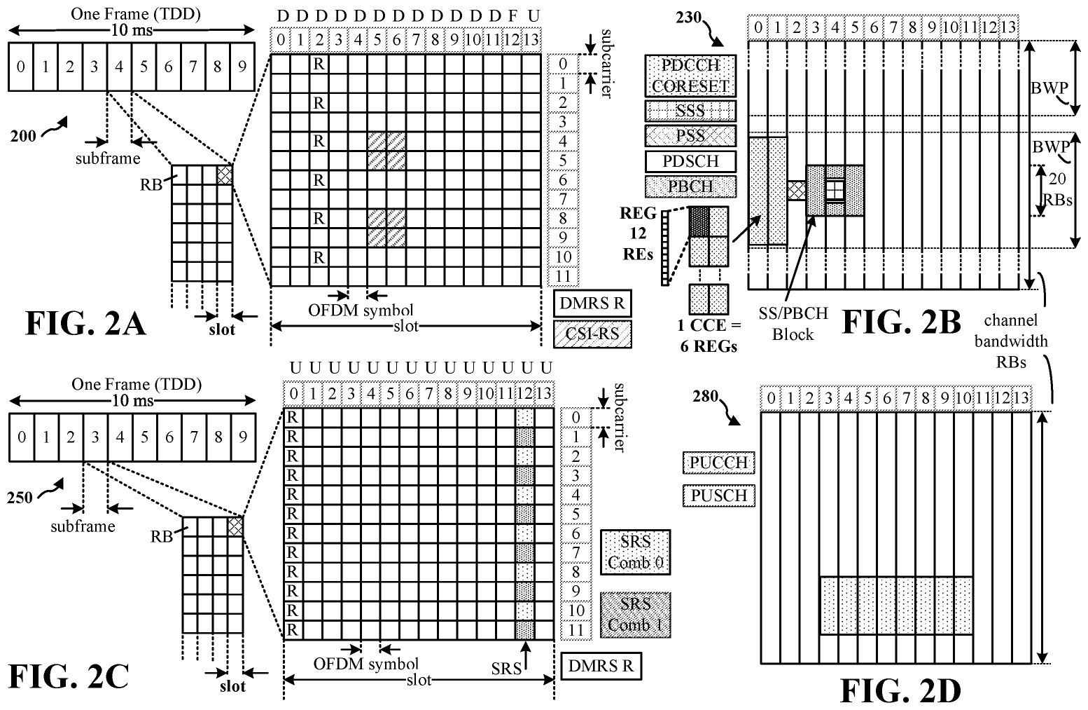

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1), the symbol length/duration, may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

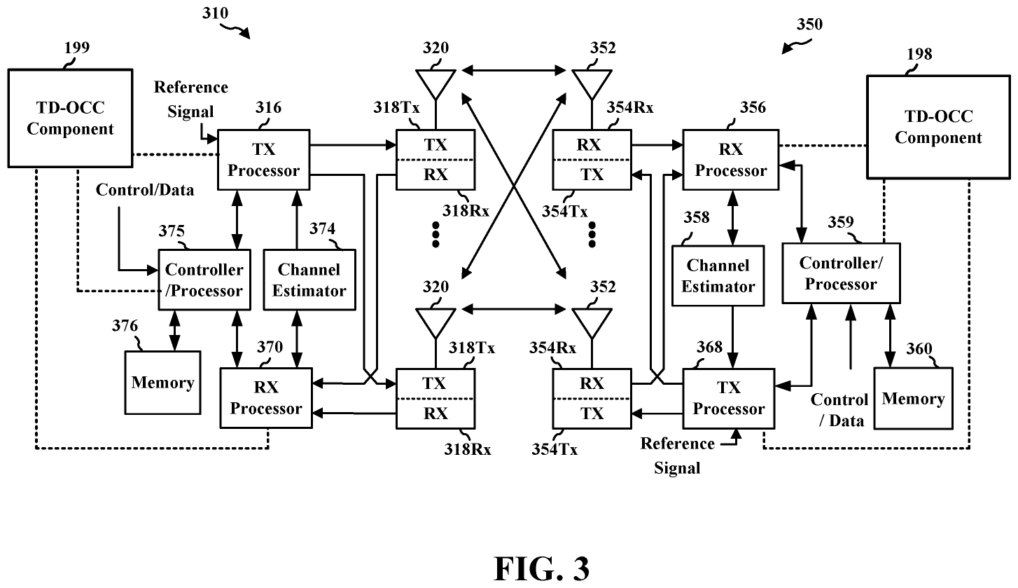

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with TD-OCC component 198 of FIG. 1.

At least one of the TX processor 316, the RX processor 370, and the controller/processor 375 may be configured to perform aspects in connection with TD-OCC component 199 of FIG. 1.

SRS is a UL reference signal transmitted by the UE in the uplink direction that may be used by a network entity to estimate an uplink channel quality over a bandwidth and/or beam direction. The UE may transmit the SRS based on a configuration received from the network. The network may then measure the SRS transmissions to estimate a channel quality. The SRS configuration may include various information, such as a comb spacing, a comb offset, timing information, etc. FIG. 2C illustrates example aspects of an SRS transmission.

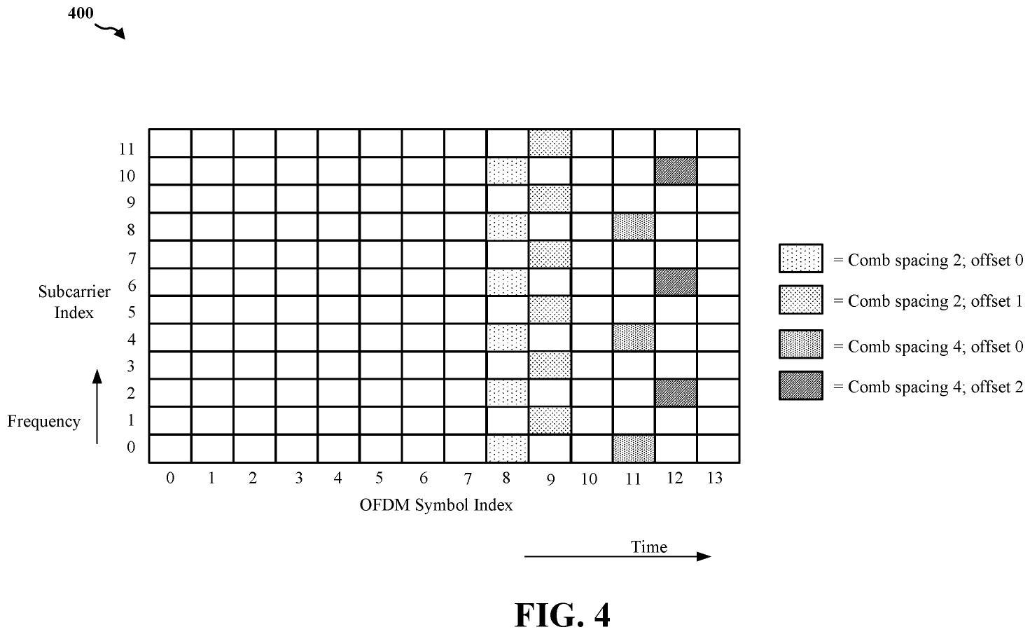

As an example, the comb spacing configured for the SRS may indicate a frequency comb spacing between SRS REs in a symbol. For example, the comb spacing (K_{TC}) for the SRS may be configured as 2, 4, or 8 per SRS resource. As an example, a comb spacing of 2 corresponds to a spacing between two SRS REs in an OFDM symbol. A comb spacing of 4 corresponds to a spacing of 4 REs between SRS resources, and a comb spacing of 8 corresponds to 8 REs between SRS resources. FIG. 4 illustrates a resource diagram 400 in time and frequency. In FIG. 4, the SRS in symbol index 8 and symbol index 9 have a comb spacing of 2, whereas the SRS in symbol indexes 11 and 12 have a comb spacing of 4. The comb offset may be indicative of a location of SRS RE, e.g., relative to a starting RE or reference RE. For example, the comb offset (k̅_{TC}) for the SRS may be configured as 0, 1, . . . , K_{TC}−1 per SRS resource, which indicates the SRS REs (e.g., by indicating a starting RE, and the SRS transmission may occupy every K_{TC} REs within the sounding BW once starting RE is determined). The diagram 400 in FIG. 4 illustrates example aspects of combinations of comb spacing and comb offset. The SRS in symbol index 8 and 11 have an offset of 0, e.g., and have a starting RE that corresponds to subcarrier index 0, or a reference subcarrier within a bandwidth that the SRS is configured to be transmitted. The SRS in symbol index 9 has a comb offset of 1, e.g., and starts in subcarrier index 1, e.g., with an offset of 1 RE or subcarrier from the reference subcarrier. The SRS in symbol index 12 has an offset of 2, and is offset from subcarrier index 0 by 2 REs

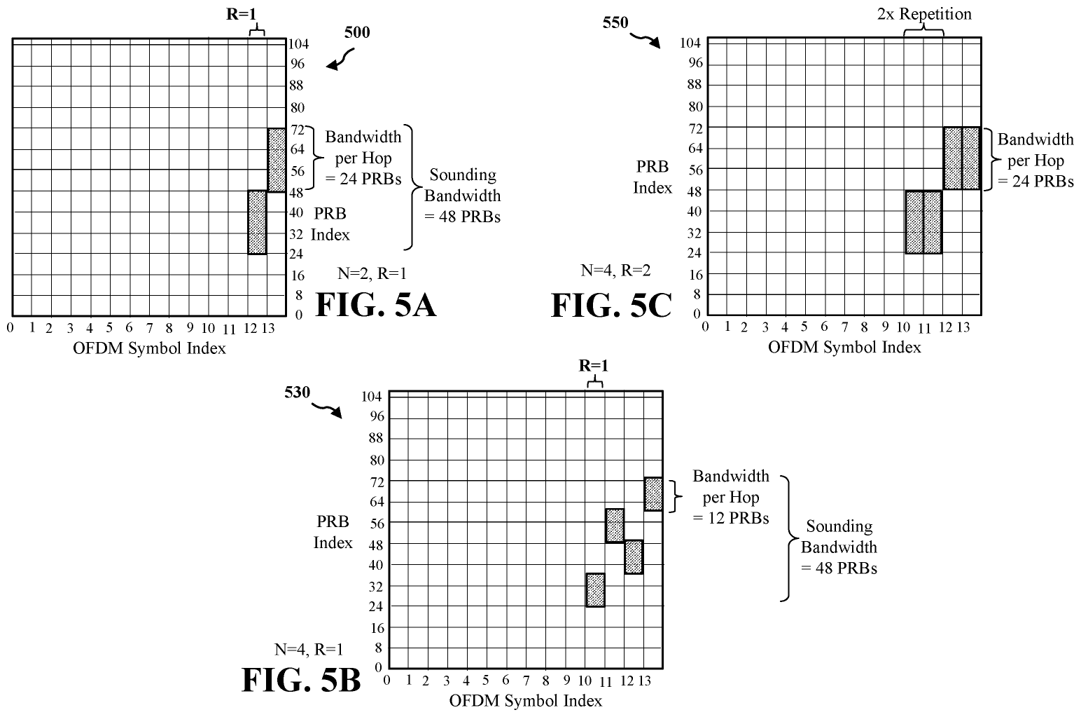

The SRS configuration may indicate a number of symbols in which the SRS is to be transmitted, and may indicate a number of repetitions for the SRS. Each SRS resource that the UE uses for transmission of the SRS and the base station uses for reception of the SRS may be configured with N OFDM symbols and R repetitions, N and R being positive integer numbers. If R<N, there are N/R frequency hops within the SRS resource. FIG. 5A is a diagram 500 illustrating an example of frequency hopping and repetition for SRS transmission. As illustrated in FIG. 5A, the sounding bandwidth associated with the SRS may be 48 PRBs, and a bandwidth per hop may be 24 PRBs. FIG. 5A illustrates an example of 2 frequency hops in this example. FIG. 5A illustrates an example in which the SRS may be configured for 2 OFDM symbols (e.g., N=2) with 1 repetition (e.g., r=1). FIG. 5B is a diagram 530 illustrating another example of frequency hopping and repetition. As illustrated in FIG. 5B, the sounding bandwidth associated with the SRS may be 48 PRBs, and a bandwidth per hop may be 12 PRBs. FIG. 5B illustrates an example of 4 hops, for an SRS configuration for 4 OFDM symbols(e.g., N=4) with 1 repetition (e.g., R=1). FIG. 5C is a diagram 550 illustrating another example of frequency hopping and repetition. As illustrated in FIG. 5C, the sounding bandwidth associated with the SRS may be 48 PRBs, and a bandwidth per hop may be 24 PRBs. FIG. 5C illustrates an example of 2 hops with 2 repetitions (e.g., R=2) for each hop over 4 OFDM symbols (e.g., N=4). Table 2 below illustrates example combinations of N and R for SRS resources.

TABLE 2

| N per SRS resource | R = Repetition factor |
|---|---|
| 1 | 1 |
| 2 | 1, 2 |
| 4 | 1, 2, 4 |
| 8 | 1, 2, 4, 8 |
| 10 | 1, 2, 5, 10 |
| 12 | 1, 2, 3, 6, 12 |
| 14 | 1, 2, 7, 14 |

A set of time and frequency resources that may be used for one or more transmissions of SRS may be referred to as an “SRS resource set”. In some communication systems, the SRS resource set applicability for an SRS resource set may be configured by a higher layer parameter, such as “usage” associated with the SRS resource set, such as in the SRS-ResourceSet parameter. For example, usage may be configured as one of beam management, codebook, non-codebook, antenna switching, or the like. Each SRS resource set may be configured with one or more (such as up to 16) SRS resources. Each SRS resource set may be aperiodic, semi-persistent, or periodic.

In some wireless communication systems, two types of PUSCH transmissions may be supported. The first type may be referred to as codebook based transmission. For codebook based transmission, a UE may be configured with one SRS resource set with “usage” set to “codebook”. For example, a maximum of 4 SRS resources within the set may be configured for the UE. Each SRS resource may be radio resource control (RRC) configured with a number of ports, such as one or more ports. The SRS resource indicator (SRI) field in the UL DCI scheduling the PUSCH may indicate one SRS resource. The number of ports configured for the indicated SRS resource may determine number of antenna ports for the PUSCH. The PUSCH may be transmitted with the same spatial domain filter (which may be otherwise referred to as a “beam”) as the indicated SRS resources. The number of layers (i.e., rank) or transmitted precoding matrix indicator (TPMI) (e.g., for precoder) for the scheduled PUSCH may be determined from a separate DCI field “Precoding information and number of layers”.

For non-codebook-based transmission, a UE may be configured with one SRS resource set with “usage” set to “non-codebook”. For example, a maximum of 4 SRS resources within the set may be configured for the UE. Each SRS resource may be RRC configured with one port. The SRI field in the UL DCI scheduling the PUSCH may indicate one or more SRS resources. A number of indicated SRS resources may determine the rank (e.g., number of layers) for the scheduled PUSCH. The PUSCH may be transmitted with the same precoder as well as a same spatial domain filter (e.g., beam) as the indicated SRS resources.

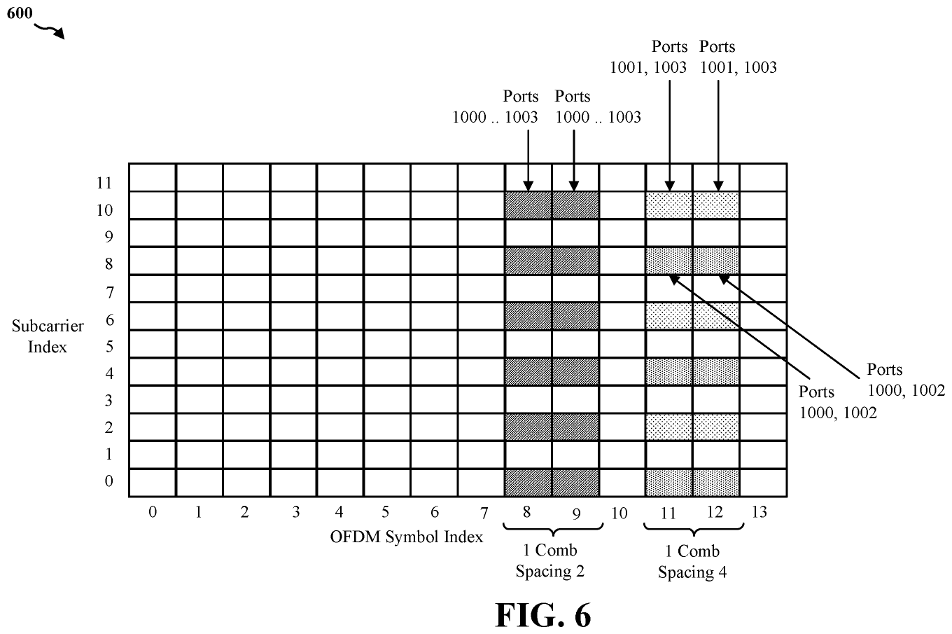

An SRS resource may correspond to one or more SRS ports. Each SRS port may correspond to an actual UE physical antenna, or a virtual antenna constructed based on an analog, digital, or other operation of the UE physical antennas. Each SRS port may be represented by a port identifier (ID). For an SRS resource associated with multiple SRS ports, different cyclic shifts and/or different comb offsets may be used for SRS transmission from different SRS ports. As used herein, the term “cyclic shift” may refer to a bitwise operation of moving one or more bits at an end to a beginning and shifting other entries to later positions. As an example, in each symbol, a set of SRS ports may be sounded either via different subcarriers, or in overlapping subcarriers with different cyclic shifts and different comb offsets. FIG. 6 is a diagram 600 illustrating an example of multiplexing of SRS transmissions from different SRS ports of a UE. As illustrated in FIG. 6, in a first example, with N=2 symbols and R=2 repetitions, 4 SRS ports (e.g., SRS ports 1000, 1001, 1002, and 1003) are sounded (e.g., an SRS transmission is transmitted from the 4 SRS ports of the UE in each SRS symbol) in the same two SRS symbols (e.g., symbol indexes 8 and 9) and with the same comb spacing and comb offset (e.g., on the same REs) using four different cyclic shifts. For example, the SRS transmission is transmitted from a first SRS port with a first cyclic shift, from a second SRS port with a second cyclic shift, from a third SRS port with a third cyclic shift, and from a fourth SRS port with a fourth cyclic shift. In a second example, N=2 symbols, and R=2 repetitions, 4 SRS ports (e.g., SRS ports 1000, 1001, 1002, and 1003) are sounded in each SRS symbol, e.g., in symbol indexes 11 and 12, with two different cyclic shifts and two different comb offsets. For example, the UE transmits SRS transmissions from SRS ports 1001 and 1003 with a comb spacing of 4 and a comb offset of 2, e.g., using a first cyclic shift for the SRS transmission from SRS port 1001 and a second cyclic shift for the SRS transmission from SRS port 1003. The UE also transmits SRS transmissions from SRS ports 1000 and 1002 with a comb spacing of 4 and a comb offset of 0, using different cyclic shifts for the SRS transmissions from the SRS ports 1000 and 1002.

For an SRS resource associated with multiple SRS ports, cyclic shifts may be evenly distributed among the ports, where the cyclic shift of the first port is RRC-configured (n_{SRS}^{cs}) for the SRS resource. For 4 ports, as an example illustrated in table 3 below, ports {0,2} and {1,3} may be separated by different comb offsets.

TABLE 3

| | | 1 antenna port | 2 antenna ports | |
|---|---|---|---|---|
| Comb | Maximum # | Nₐₚ = 1 | Nₐₚ = 2 | 4 antenna ports |
| Spacing | Cyclic Shifts: | Assigned | Assigned cyclic | Nₐₚ = 4 |
| K_{TC} | n_{SRS}^{cs, max} | cyclic shifts | shifts | Assigned cyclic shifts |
| 2 | 8 | n_{SRS}^{cs} | (n_{SRS}^{cs} + | (n_{SRS}^{cs} + {0, 2, 4, 6})mod8 |
| | | | {0, 4})mod8 | When n_{SRS}^{cs} is in the second half, |
| | | | | Ports (0, 2) and (1, 3) have |
| | | | | different comb offsets |
| 4 | 12 | n_{SRS}^{cs} | (n_{SRS}^{cs} + | (n_{SRS}^{cs} + {0, 3, 6, 9})mod12 |
| | | | {0, 6})mod12 | When n_{SRS}^{cs} is in the second half, |
| | | | | Ports (0, 2) and (1, 3) have |
| | | | | different comb offsets |
| 8 | 6 | n_{SRS}^{cs} | (n_{SRS}^{cs} + | (n_{SRS}^{cs} + {0, 3})mod6 |
| | | | {0, 3})mod6 | Ports (0, 2) and (1, 3) have same |
| | | | | cyclic shifts but different comb |
| | | | | offsets in this case |

In some aspects, k_{TC}^{(p}^{ᵢ}⁾ may be equal to:

$$\{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) mod {K}_{TC} & \begin{matrix}if {N}_{ap}^{SRS} = 4 , {p}_{i} ∈ \{ 1001 , 1003 \} , \\ and {n}_{SRS}^{cs} ∈ \{ {n}_{SRS}^{cs , max} / 2 , … , {n}_{SRS}^{cs , max} - 1 \}\end{matrix} \\ {\overline{k}}_{TC} & otherwise\end{matrix} )$$

In some aspects, the SRS transmission from different SRS ports may be transmitted with a TD-OCC. For example, the UE may transmit the SRS in two different REs that are on the same subcarrier but different symbols, and the two SRS ports may be code division multiplexed (CDMed) using an OCC of {1,1} and {1,−1}. That is, in the first RE, p1+p2 may be transmitted, and in the 2^{nd} RE, p1−p2 may be transmitted, where p1 represents the SRS of first port and p2 represents the SRS of the second port. In another example, for 4 SRS ports, a 4 port TD-OCC={{1,1,1,1}, {1,−1,1,−1},{1,1,−1,−1}, {1,−1,−1,1}} can be used: p1+p2+p3+p4 on the first symbol, p1−p2+p3−p4 on the second symbol, p1+p2−p3−p4 on the third symbol, p1−p2−p3+p4 on the fourth symbol, where p3 represents the SRS for the third port and p2 represents the SRS for the fourth port. For a TD-OCC of length X, where X is a power of 2 (2, 4, 8, . . . ), orthogonal codes such as Walsh codes of length X may be used across X symbols. Walsh code may be orthogonal codes where all the members in the set are orthogonal to each other. Other codebooks such as DFT-based or e.g., {1, j, 1, j}, {1, −j, 1, −j} may be also used for TD-OCC. TD-OCC can be also used across different UEs, or across different ports of a UE and across different UEs. As an example, a first UE (UE1) may be configured with an SRS resource for 2 SRS ports using a TD-OCC of {1,1,1,1} and {1,−1,1,−1} across 4 OFDM symbols. A second UE (UE2) may be configured with an SRS resource with 2 ports using a TD-OCC of {1,1,−1,−1} and {1,−1,−1,1} across 4 OFDM symbols. Table 4 below shows an example configuration of the first UE and the second UE:

TABLE 4

| | Symbol | Symbol | Symbol | Symbol |
|---|---|---|---|---|
| | 1 | 2 | 3 | 4 |
| First SRS port of UE1 | 1 | 1 | 1 | 1 |
| Second SRS port of UE1 | 1 | −1 | 1 | −1 |
| First SRS port of UE2 | 1 | 1 | −1 | −1 |
| Second SRS port of UE2 | 1 | −1 | −1 | 1 |

As the same cyclic shift and the same comb offset may be used for multiple SRS ports of the SRS resource or for multiple UEs, the overall capacity for the SRS sounding of multiple SRS ports (e.g., and overlapping SRS sounding of different UEs) may be increased. Some aspects provided herein provide different configurations or UE capability with regard to whether TD-OCC is used across different UEs, or across different ports of the same UE (same SRS resource) and rules regarding number of unique TD-OCC sequences that can be configured for a SRS resource with P ports. For the case that TD-OCC is applied for SRS transmission of the same SRS resource at different SRS ports, aspects provided herein may provide mechanisms for the UE and base station to determine a cyclic shift and/or comb offset based on whether SRS ports apply the same TD-OCC sequence or different TD-OCC sequences.

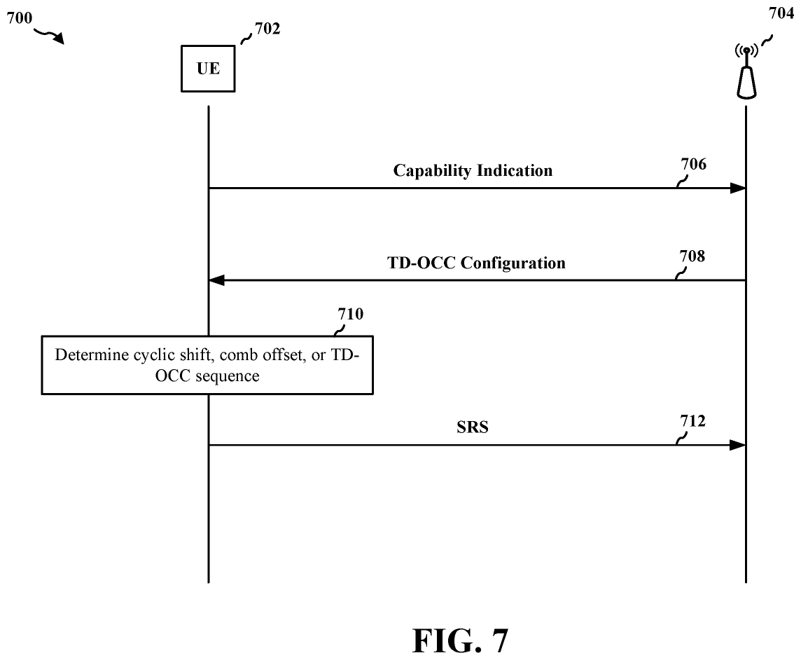

FIG. 7 is a diagram 700 illustrating example communications between a network entity 704 and a UE 702. The network entity 704 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 7, the UE 702 may receive a TD-OCC configuration 708 from the network entity 704. The TD-OCC configuration 708 may provide different configurations with regard to whether TD-OCC is used across different UEs, or across different ports of the same UE (same SRS resource). In some aspects, a single TD-OCC sequence may be applied across each of the SRS ports. In other aspects, different TD-OCC sequences may be applied to different SRS ports. Aspects presented herein provide rules regarding a number of unique TD-OCC sequences that can be configured for a SRS resource with P ports. The UE 702 may determine a cyclic shift, a comb offset, or a TD-OCC sequence, at 710, for an SRS transmission from different ports. Then, the UE transmits SRS from the multiple ports, at 712, using the determine cyclic shift, comb offset, comb spacing, and TD-OCC sequence, e.g., as determined at 710.

In some aspects, the TD-OCC configuration 708 may implicitly or explicitly configure the UE 702 to apply the same TD-OCC sequence all SRS ports in SRS 712. As an example, the configuration at 708 may provide one, e.g., a single, TD-OCC sequence that is configured for the SRS resource (M=1), which is applied to all SRS ports, where M is a positive integer number that represents the number of unique TD-OCC sequences configured for the SRS resource.

In some aspects, the TD-OCC configuration 708 may implicitly or explicitly configure the UE 702 to apply different TD-OCC sequences to different SRS ports in the SRS 712. In some aspects, multiple unique TD-OCC sequences may be configured for the SRS resource, e.g., M>1. The TD-OCC length (number of symbols over which the TD-OCC is applied) may be denoted as X, and P represents a number of SRS ports (which may also be denoted as Nₐₚ^{SRS}).

In some aspects, a rule for the TD-OCC configuration 708 may represent that the number of unique TD-OCC sequences is less than or equal to the number of SRS ports (e.g., M≤P)). In such an example, at a maximum, P TD-OCC sequences may be used, one for each SRS port. In some aspects, a rule for the TD-OCC configuration 708 may represent the number of unique TD-OCC sequences is less than or equal to the TD-OCC length (e.g., M≤X). In this example, a maximum number of TD-OCC sequences is equal to the length of the sequence (e.g., for Walsh code or other orthogonal code). In some aspects, a rule for the TD-OCC configuration 708 may represent that a ratio of the number of SRS ports to the number of unique TD-OCC sequences (e.g., P/M) is an integer number. For example, if P=4, M can be 1 (e.g., so that a single TD-OCC sequence is applied across each of the multiple SRS ports), 2, or 4, but it not 3, which would lead to a non-integer ratio of P/M. K (e.g., K=P/M) may represent the number of ports that use the same (e.g., a shared) TD-OCC sequence. If P/M is an integer value, the number of ports in each group that uses the same TD-OCC sequence may be the same. If P/M is not an integer, at least one group of ports (that use the same TD-OCC sequence) may be larger than another group (that use another TD-OCC sequence).

In some aspects, whether the TD-OCC configuration 708 may implicitly or explicitly indicate for the UE 702 whether to apply different TD-OCC sequences to different SRS ports in the SRS 712 or to apply the same TD-OCC sequence all SRS ports in SRS 712. In some aspects, the configuration may include an indication to apply different TD-OCC sequences to different SRS ports. In some aspects, the configuration may include an indication to apply the same TD-OCC sequence to different SRS ports. In some aspects, a value of M (e.g., the number of unique TD-OCC sequences) configured in the configuration may provide the indication to the UE. In some aspects, the UE 702 may provide a capability indication 706 indicating UE capability relating to TD-OCC for SRS transmissions to the network entity 704. As an example, the UE may indicate that it supports the application of different TD-OCC sequences across different SRS ports. The UE may indicate that it supports the application of a single TD-OCC sequence across different SRS ports, e.g., which may indicate that the UE does not support the application of different TD-OCC sequences across multiple SRS ports. In some aspects, an absence of a capability indication from the UE may indicate that the UE does not support different TD-OCC sequences across multiple SRS ports, e.g., and instead supports a single TD-OCC sequence across multiple SRS ports. In some aspects, the UE 702 may apply the same TD-OCC sequence multiple SRS ports (e.g., each SRS port for an SRS resource) in SRS 712, if there is no signaling in the TD-OCC configuration 708 that provides otherwise. In some aspects, the capability indication 706 from the UE may also indicate a maximum supported value of M. For example, for a UE supporting 4 SRS ports and Case 2 TD-OCC, UE may support up to 2 TD-OCC sequences for the 4 SRS ports, but not 4 TD-OCC sequences.

In some aspects, the M TD-OCC sequences for the UE 702 to apply across different SRS ports may be explicitly provided in the TD-OCC configuration 708. For example, the configuration at 708 may include an RRC configuration that provides M sequences for each SRS resource configured for the UE. In some aspects, a set of the possible TD-OCC sequences that the UE 702 may apply may be known or defined, such as in a standard. As an example, the set of possible TD-OCC sequences may include a Walsh code that is known to the UE. Each of the possible TD-OCC sequences may be associated with an index or other identifier. The configuration, at 708, may include M indices associated with M of the possible TD-OCC sequences (e.g., via radio resource control (RRC) signaling) per SRS resource. By receiving the index in the configuration, at 708, the UE may be able to identify the corresponding TD-OCC sequence. In some aspects, a number of configured sequences may be signaled to the UE 702 to determine the value of M and to identify the corresponding TD-OCC sequences. In some aspects, a set of the possible TD-OCC sequences that the UE 702 may apply may be known at the UE 702 without network signaling (e.g., a Walsh code) such as a set of possible TD-OCC sequences that are defined, and the set may include T sequences with indices 0, 1, . . . , T−1. The network entity 704 may configure (e.g., via RRC signaling) (e.g., in the TD-OCC configuration 708), an index associated with a first or initial TD-OCC sequence (e.g., represented by t0) and the quantity of TD-OCC sequences (correspond to value of M). The UE 702 may determine the remaining M−1 TD-OCC sequences based on a rule. In some aspects, the rule may represent consecutive indices such as (t0+m) Mod T, where m=0, 1, . . . , M−1. In some aspects, the rule may represent uniformly distributed indices across the T indices such as (t0+m*T/M) Mod T, where m=0, 1, . . . , M−1. Table 4 and table 5 below illustrate different possible TD-OCC sequences.

TABLE 4

| Sequence index | TD-OCC sequence |
|---|---|
| 0 | +1, +1, +1, +1 |
| 1 | +1, −1, +1, −1 |
| 2 | +1, +1, −1, −1 |
| 3 | +1, −1, −1, +1 |

TABLE 5

| | Network configuration | UE determination |
|---|---|---|
| Configuration of the | (+1, −1, +1, −1) and | (+1, −1, +1, −1) and |
| sequences provided in the | (+1, −1, −1, +1) | (+1, −1, −1, +1) |
| TD-OCC configuration | | |
| M indices configured with | Index 2 and 3 | (+1, +1, −1, −1) and |
| reference to a known set of | | (+1, −1, −1, +1) |
| possible TD-OCC | | |
| sequences | | |
| First sequence and number | M = 2, and index 3 | (+1, −1, −1, +1) and |
| of sequences from known | | (+1, +1, +1, +1) |
| set of possible TD-OCC | | |
| sequences, M configured | | |
| based on consecutive | | |
| indices | | |
| First sequence and number | M = 2, and index 3 | (+1, −1, −1, +1) and |
| of sequences from known | | (+1, −1, +1, −1) |
| set of possible TD-OCC | | |
| sequences, M configured | | |
| based on uniformly | | |
| distributed indices. | | |

In some aspects, at 710, when one (e.g., a single) TD-OCC sequence is configured for the SRS resource (M=1), which is applied to all SRS ports, the UE 702 may determine that SRS ports for SRS 712 are not orthogonalized by TD-OCC, and the UE may transmit the SRS at different SRS ports on the same SRS resource with either different cyclic shifts or different comb offsets. For example, for 2 SRS ports, the UE may transmit SRS from the two SRS ports with same comb offset but different cyclic shifts. For 4 SRS ports, depending on the comb spacing or initial configured cyclic shift, the SRS transmission on the same SRS resource for different SRS ports may either have the same comb offset but different cyclic shifts, or the SRS transmission from ports {0,2} may be transmitted the first comb offset while the SRS transmission from SRS ports {1,3} may have another comb offset (and SRs transmission from SRS ports with the same comb offset may have different cyclic shifts).

In some aspects, at 710, when the UE 702 applies different TD-OCC sequences to different SRS ports for the SRS 712, if M=P, all the ports may be on the same comb offset and have a same cyclic shift (as the SRS transmission for different ports are orthogonalized by the TD-OCC). In some aspects, at 710, when the UE 702 applies different TD-OCC sequences to different SRS ports in the SRS 712, if M<P, for SRS ports two which the same TD-OCC sequence is applied, the UE may use different cyclic shifts or different comb offsets to help distinguish the SRS transmissions from different SRS ports. In some aspects, at 710, when the UE 702 applies different TD-OCC sequences to different SRS ports in the SRS 712, if M<P, for ports with different TD-OCC sequences, the UE may use the same cyclic shift and the same comb offset. In some aspects, the UE may group SRS ports based on whether the UE supports use of the same TD-OCC sequence for different SRS ports.

In some aspects, the UE 702 may apply different TD-OCC sequences to different SRS ports for the SRS 712, if M<P, and K=P/M is an integer and larger than 1. In some of such aspects, the P SRS ports are grouped into M groups. Within a group, a same TD-OCC sequence may be applied. Across different groups, different TD-OCC sequence may be applied. Each group may include K ports. In some aspects, consecutive port numbers may belong to the same group, e.g., ports {0, 1, . . . , K−1} are in the first group, ports {K, K+1, . . . , 2K−1} are in the second group, . . . , and ports {P−K, . . . , P−1} belong to the M'th group. In some aspects, Port numbers with the same Modulo with regard to M are in the same group, e.g., ports {0, M, . . . , (K−1)M} are in the first group, ports {1, M+1, . . . , (K−1)M+1} are in the second group, . . . , and ports {M−1, 2M−1, . . . , P−1} are in the M'th group. In some aspects, within a group of ports, different cyclic shift or comb offset may be used for different ports. In some aspects, the first port index within each group may have a cyclic shift n_{SRS}^{cs} (e.g., which may be RRC configured) (e.g., configured in TD-OCC configuration 708). In some aspects, if K=2, the two ports in the group may have same comb offset but different cyclic shifts. In some aspects, the second port index within the group may have cyclic shift (n_{SRS}^{cs}+n_{SRS}^{cs,max}/2)mod n_{SRS}^{cs,max}, where n_{SRS}^{cs,max} represent the max number of cyclic shifts (corresponding to a comb spacing). In some aspects, if K=4, the four ports in the group may either have same comb offset but different cyclic shifts (for comb spacing 2 and 4 and when the configured n_{SRS}^{cs} is in the first half) or first and third ports within the group may be on the first comb offset while second and fourth ports within the group may be on another comb offset, and ports within the same comb offset may have different cyclic shifts (for comb spacing 8, or for comb spacing 2 and comb spacing 4 and when the configured n_{SRS}^{cs} is in the second half). In some aspects, across different groups and for the i'th port index of each group, different ports may have the same cyclic shift and the same comb offset.

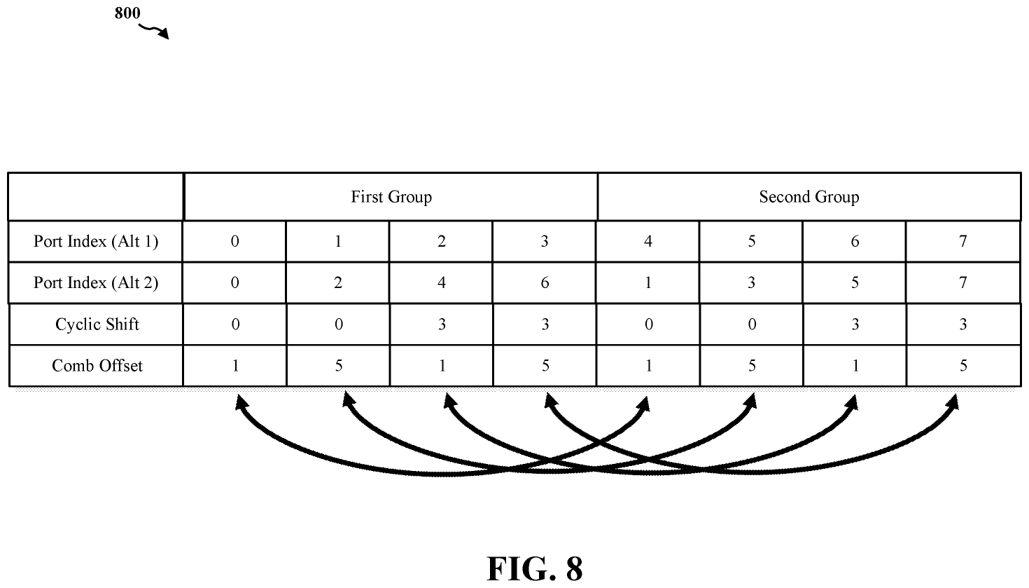

FIG. 8 is a diagram 800 illustrating an example application of cyclic shift and comb offset across port indexes based on port grouping. As an example, if P=8, M=2 and K accordingly equal to 4, if configured cyclic shift is 0 (n_{SRS}^{cs}), configured comb offset is 1 (k̅_{TC}), and comb spacing is 8 (n_{SRS}^{cs,max} is 6), in some aspects, there may be 2 groups each with 4 ports. In some aspects where consecutive port numbers belong to the same group, the first group includes ports {0,1,2,3} and the second group includes ports {4,5,6,7}. In some aspects where port numbers with the same Modulo with regard to M are in the same group, the first group includes ports {0,2,4,6} and second group includes ports {1,3,5,7}. In some aspects, the first group uses TD-OCC sequence {1,1} and the second group uses TD-OCC sequence {1,−1}. Within a group, for cyclic shift and comb offset, the four ports in the group may either have same comb offset but different cyclic shifts (for comb spacing 2 and 4 and when the configured ns s is in the first half) or first and third ports within the group are on the first comb offset while second and fourth ports within the group are on another comb offset, and ports within the same comb offset have different cyclic shifts (for comb spacing 8, or for comb spacing 2 and 4 and when the configured n_{SRS}^{cs} is in the second half). In some aspects, the cyclic shift and comb offset for i'th port of the two groups is the same.

In some aspects the UE 702 may apply different TD-OCC sequences to different SRS ports in the SRS 712, M<P, and K=P/M is integer and larger than 1. In some of such aspects, the P SRS ports may be grouped into K groups. Within a group, different TD-OCC sequence is applied. Same TD-OCC sequence may be applied to the i'th port of each group. Each group includes M ports. In some aspects, consecutive port numbers belong to the same group, e.g., ports {0, 1, . . . , M−1} are in the first group, ports {M, M+1, . . . , 2M−1} are in the second group, . . . , and ports {P-M, . . . , P−1} belong to the K'th group. In some aspects, port numbers with the same Modulo with regard to K are in the same group, i.e., ports {0, K, . . . , (M−1)K} are in the first group, ports {1, K+1, . . . , (M−1)K+1} are in the second group, . . . , and ports {K−1, 2K−1, . . . , P−1} are in the K'th group. In some aspects, within a group of ports, same cyclic shift and same comb offset is used for different ports. In some aspects, across different groups, different cyclic shift or comb offset is used. In some aspects, the first group may have cyclic shift ns s (e.g., RRC configured) (e.g., configured in TD-OCC configuration 708). In some aspects, if K=2, the first and second groups may have same comb offset but different cyclic shifts. In some aspects, the second group may have cyclic shift (n_{SRS}^{cs}+n_{SRS}^{cs,max}/2)mod n_{SRS}^{cs,max}, where n_{SRS}^{cs,max} is the max number of cyclic shifts (corresponding to a comb spacing). In some aspects, if K=4, the four groups may either have a same comb offset but different cyclic shifts (for comb spacing 2 and 4 and when the configured n_{SRS}^{cs} is in the first half) or first and third groups may be on the first comb offset while second and fourth groups are on another comb offset, and ports within the same comb offset have different cyclic shifts (for comb spacing 8, or for comb spacing 2 and 4 and when the configured n_{SRS}^{cs} is in the second half). Table 6 below provides an example:

TABLE 6

| | First | | Second | | Third | | Fourth | |
|---|---|---|---|---|---|---|---|---|
| | group | | group | | group | | group | |
| Port index | 0 | 1 | 2 | 3 | 4 | 5 | 6 | 7 |
| (Consecutive port | | | | | | | | |
| numbers belong to | | | | | | | | |
| the same group) | | | | | | | | |
| Port index (Port | 0 | 4 | 1 | 5 | 2 | 6 | 3 | 7 |
| numbers with the | | | | | | | | |
| same Modulo with | | | | | | | | |
| regard to K are in | | | | | | | | |
| the same group) | | | | | | | | |

| | | | | |
|---|---|---|---|---|
| Cyclic shift | 0 | 0 | 3 | 3 |
| Comb offset | 1 | 5 | 1 | 5 |

As illustrated in table 6, when P=8, M=2 and K=4, if configured cyclic shift is 0 (n_{SRS}^{cs}), configured comb offset is 1 (k̅_{TC}), and comb spacing is 8 (n_{SRS}^{cs,max} is 6). There may be 4 groups each with 2 ports. When consecutive port numbers belong to the same group, the first group includes ports {0,1}, the second group includes ports {2,3}, the third group includes ports {4,5}, and the fourth group includes ports {6,7}. When port numbers with the same Modulo with regard to K are in the same group, first group includes ports {0,4}, second group includes ports {1,5}, third group includes ports {2,6}, and fourth group includes ports {3,7}. For each group, the first port may apply TD-OCC sequence {1,1} and the second port may apply TD-OCC sequence {1,−1}. Within a group, same comb offset and cyclic shift may be used. Across groups, for cyclic shift and comb offset, the four groups may either have a same comb offset but different cyclic shifts (for comb spacing 2 and 4 and when the configured n_{SRS}^{cs} is in the first half) or first and third groups may be on the first comb offset while second and fourth groups are on another comb offset, and ports within the same comb offset have different cyclic shifts (for comb spacing 8, or for comb spacing 2 and 4 and when the configured n s is in the second half).

In some wireless communication systems without TD-OCC for SRS, when a set of symbols of the SRS resource are dropped, the remaining symbols may still be transmitted. SRS dropping may be performed at a per-symbol level (e.g., whereas PUCCH/PUSCH dropping may not be performed at a per-symbol level). However, when TD-OCC is used to orthogonalize SRS of multiple UEs or multiple ports of the same SRS resource of the same UE, dropping one symbol in an SRS transmission may result in loss of orthogonalization on the remaining symbols in the SRS transmission. For example, if two UEs use TD-OCC sequences of [+1,+1] and [+1,−1] over two OFDM symbols (using the same comb offset and cyclic shift), if the first symbol of the first UE is dropped, the two SRS on the second symbol may experience large interference as [0,+1] and [+1,−1] are no longer orthogonal. Dropping the remaining symbols within the TD-OCC if at least one symbol is dropped may avoid the interference, but may be inefficient. Aspects provided herein may provide efficient mechanisms for dropping SRS symbols in SRS for TD-OCC. In some aspects, dropping may not be used for all UEs. In some aspects, instead of dropping, a UE may change some of the SRS parameters to mitigate the interference and still transmit the remaining symbols. Some aspects provided herein may allow network with flexibility to control the behavior for different SRS resources or different UEs in various scenarios.

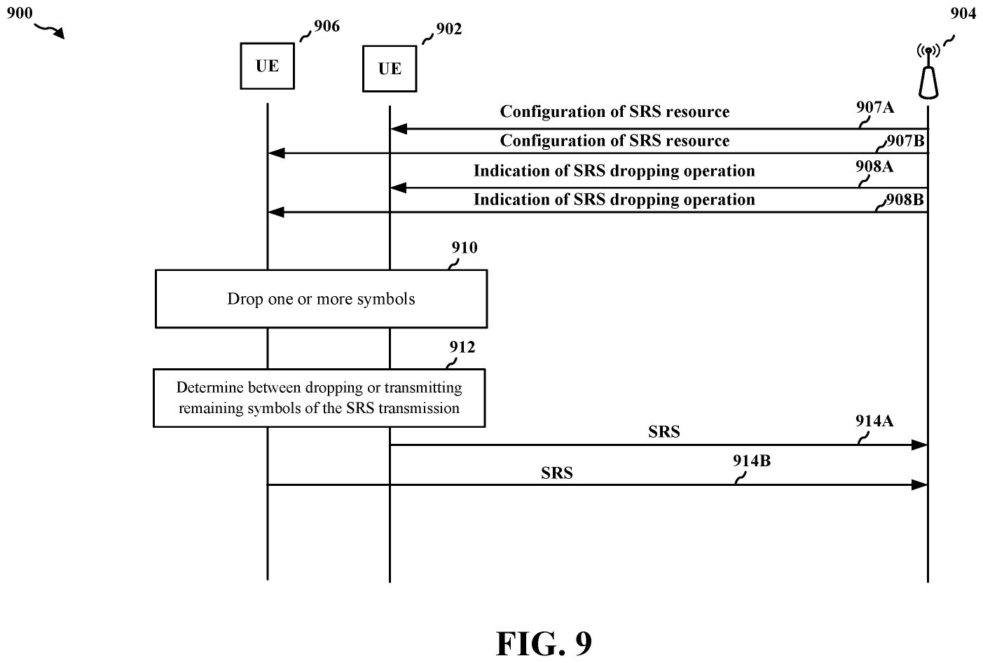

FIG. 9 is a diagram 900 illustrating example communications between a network entity 904, a UE 902, and a UE 906. The network entity 904 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 9, the network entity 904 may transmit a configuration 907A of SRS resources for an SRS 914A to the UE 902 and a configuration 907B of SRS resources for an SRS 914B to the UE 906. In some aspects, the UE 902 may receive an indication 908A of SRS dropping associated with the SRS 914A from the network entity 904. In some aspects, the UE 906 may receive an indication 908B of SRS dropping associated with the SRS 914B from the network entity 904. In some aspects, the UE 902 or the UE 906 may drop one or more symbols of the SRS 914A at 910. In some aspects, the dropping at 910 may be due to one or more of: 1) overlap in time with SSB symbols, 2) overlap in time with dynamic DL signals or channels, 3) overlap in time with other UL signals or channels with a higher priority, 4) indicated to be canceled based on uplink cancellation indication (ULCI) (e.g., in DCI format 2_4), or 5) slot format indicator (SFI) related. An example of overlap in time with dynamic DL signals or channels may be SRS is periodic or semi-persistent (e.g., higher layer configured) on a set of symbols where downlink control information (DCI) may schedule CSI-RS or PDSCH on a subset of the set of symbols. An example of overlap in time with other UL signals or channels with a higher priority may be overlapping with PUSCH. If SRS overlaps with PUCCH, SRS is dropped unless the SRS is aperiodic SRS triggered to be transmitted to overlap in the same symbol with PUCCH carrying semi-persistent/periodic CSI report(s) or semi-persistent/periodic layer 1 (L1) reference signal received power (RSRP) report(s) or L1 signal to interference and noise (SINR) report(s). In some aspects, when different SRS resources overlap, SRS with higher priority may be transmitted and SRS with lower priority may be dropped. As an example, aperiodic (AP) SRS may have higher priority than semi-persistent (SP) SRS, and semi-persistent SRS may have higher priority than periodic (P) SRS. In some aspects, SFI related dropping may apply when UE is configured to monitor DCI format 2_0 for dynamic SFI indication. If P/SP SRS is configured in a set of symbols, and dynamic SFI indicates “flexible” or “DL” on those symbols, SRS may be dropped. If P/SP SRS is configured in a set of symbols that are flexible as indicated by higher layers, a UE may be configured to monitor DCI format 2_0 (dynamic SFI) but the UE may not detect the DCI format 2_0.

DCI format 0_0 may be a fallback format that may provide scheduling of a PUSCH in one cell. DCI format 0_1 may be a non-fallback format that may provide scheduling of a PUSCH in one cell. DCI format 1_0 may be a fallback DCI format used for allocating downlink resources for a PDSCH. DCI format 1_1 may be a non-fallback DCI format used for allocating downlink resources for a PDSCH. DCI format 2_0 may be used for the notification of slot format information (to dynamically change the slot format). DCI format 2_1 may be used for notifying the PRB(s) and OFDM symbol(s) where a UE may assume no transmission is intended for the UE. DCI format 2_2 may be used for the transmission of transmit power control (TPC) commands for a PUCCH and a PUSCH. DCI format 2_3 may be used for the transmission of a group of TPC commands for SRS transmissions by one or more UEs. DCI format 2_4 may be used for, such as dedicated for, providing cancellation of a UL transmission.

In some aspects, the UE 902 or the UE 906 may determine between dropping or transmitting remaining symbols of the SRS transmission at 912. In some aspects, when TD-OCC of length X is applied to X symbols of an SRS resource, if a UE (e.g., UE 902 or UE 906) drops one or more symbols of the X symbols at 910, the UE may determine one of the following behaviors for the remaining of the X symbols: 1) Drop the remaining of the X symbols, 2) transmit the remaining of the X symbols using the original configured parameters (e.g., cyclic shift or comb offset), or 3) transmit the remaining of the X symbols using a different set of SRS parameters (e.g., cyclic shift or comb offset) in response to dropping the one or more symbols. In some aspects, if the UE (e.g., UE 902 or UE 906) transmit the remaining of the X symbols using a different set of SRS parameters (e.g., cyclic shift or comb offset) in response to dropping the one or more symbols, the different set of SRS parameters may be changed based on: 1) transmit a subset of ports and not transmit the other ports, or 2) change the cyclic shift or comb offset only for a subset of ports and use the original configured cyclic shift/comb offset for the other ports. In some aspects, when different TD-OCC sequences is used within the ports of the same SRS resource (where the different TD-OCC sequences have the same cyclic shift and comb offset), the UE may transmit the remaining of the X symbols using a different set of SRS parameters (e.g., cyclic shift or comb offset) in response to dropping the one or more symbols. In some aspects, because the orthogonality given by TD-OCC between ports is lost due to dropping the one or more symbols, either one port may not be transmitted or one port may use a different comb offset or cyclic shift. In some aspects, the different set of SRS parameters may be changed based on not applying TD-OCC in the remaining of the X symbols because the TD-OCC with the original length may not be used.

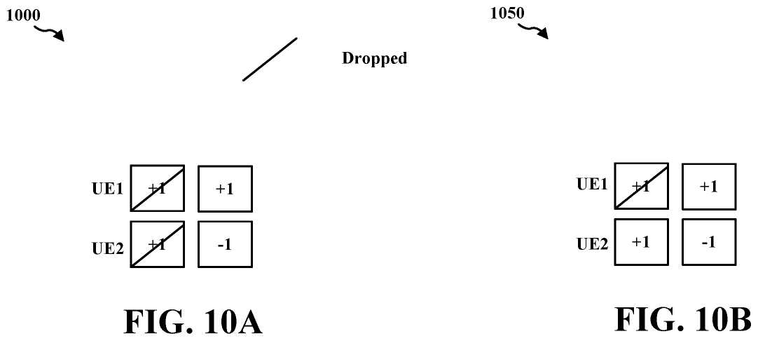

FIG. 10A is a diagram 1000 illustrating an example of dropping SRS symbol. UE 1 may correspond to the UE 902 and UE 2 may correspond to the UE 906. As illustrated in FIG. 10A, symbols at a same time are dropped. at least one of the two UEs may either drop the second symbol or change the cyclic shift or comb offset to avoid the interference. The other UE may transmit the remaining of the X symbols using the original configured parameters.

FIG. 10B is a diagram 1050 illustrating an example of dropping SRS symbol. UE 1 may correspond to the UE 902 and UE 2 may correspond to the UE 906. As illustrated in FIG. 10B, UE 1 dropped a first symbol. UE 1 may either drop the second symbol or change the cyclic shift or comb offset to avoid the interference with the SRS symbol of UE2.

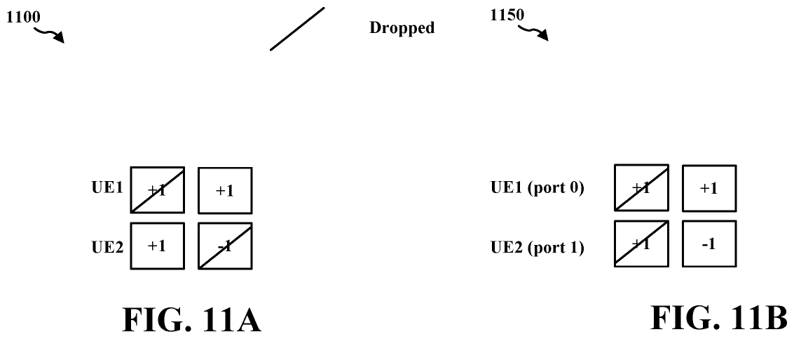

FIG. 11A is a diagram 1100 illustrating an example of dropping SRS symbol. UE 1 may correspond to the UE 902 and UE 2 may correspond to the UE 906. As illustrated in FIG. 11A, because symbols at different times are dropped, UE 1 and UE 2 may transmit the remaining of the X symbols using the original configured parameters.

FIG. 11B is a diagram 1150 illustrating an example of dropping SRS symbol. UE 1 may correspond to the UE 902 and UE 2 may correspond to the UE 906. As illustrated in FIG. 11B, symbols at a same time are dropped and the symbols may be associated with different antenna ports. The UEs may either drop the second SRS symbol as well for both ports, transmit in one of the two ports, or change the cyclic shift or comb offset for one of the ports.

In some aspects, the UE 902 or the UE 906 may determine between dropping or transmitting remaining symbols of the SRS transmission based on the indication (e.g., 908A) of SRS dropping operation or the indication of SRS dropping operation (e.g., 908B).

In some aspects, the UE 902 or the UE 906 may determine between dropping or transmitting remaining symbols of the SRS transmission based at least in part on the priority of SRS resource for SRS 914A or SRS 914B.

In some aspects, the UE 902 or the UE 906 may determine between dropping or transmitting remaining symbols of the SRS transmission based at least in part on the reason that the one or more symbols are dropped at 910. For example, remaining symbols of AP SRS may be transmitted with the original configured parameters and remaining symbols of periodic SRS may be dropped. In some aspects, the priority of SRS resource can be also a function of whether the SRS resource is configured with TD-OCC or not (e.g., if conflicting SRS resources are both for a UE and one of them is configured with TD-OCC). For example, if ULCI results in dropping, then the remaining symbols may be transmitted based on the original parameters. For example, because DCI format 2-4 may indicate a set of symbols on which SRS (or PUSCH) is canceled, the network entity 904 may (or may not) indicate the remaining symbols to be also dropped. In some aspects, there may be no reason to drop the remaining symbols. In some aspects, whether to drop or transmit remaining symbols of the SRS transmission may defined for each of the reasons to drop at 910. For example, dropping the remaining symbols, transmit remaining symbols with original parameters, or transmit remaining symbols with changed parameters may be defined for dropping based on each of: 1) overlap in time with SSB symbols, 2) overlap in time with dynamic DL signals or channels, 3) overlap in time with other UL signals or channels with a higher priority, 4) indicated to be canceled based on uplink cancellation indication (ULCI) (e.g., in DCI format 2_4), or 5) SFI related. In some aspects, the UE 902 or the UE 906 may determine between dropping or transmitting remaining symbols of the SRS transmission differently based on different reasons for dropping. For example, the UE may determine between dropping or transmitting remaining symbols of the SRS transmission based on the indication for overlap in time with SSB symbols and may determine between dropping or transmitting remaining symbols of the SRS transmission based on the priority for ULCI.

In some aspects, the UE 902 or the UE 906 may determine between dropping or transmitting remaining symbols of the SRS transmission based at least in part on the usage of the SRS 914A or the SRS 914B. As an example, each SRS resource set may be configured with one of four usages (beam management, codebook, non-codebook that may be used for PUSCH, and antenna switching that may be used for DL CSI acquisition). In some aspects, whether to drop or transmit remaining symbols of the SRS transmission may defined for each of the usage.

In some aspects, for AP/SP/P SRS, the UE 902 or the UE 906 may determine between dropping or transmitting remaining symbols of the SRS transmission differently. For example, the UE 902 or the UE 906 may determine between dropping or transmitting remaining symbols of the SRS transmission based on the indication or based at least in part on the priority for different types of AP/SP/P SRS.

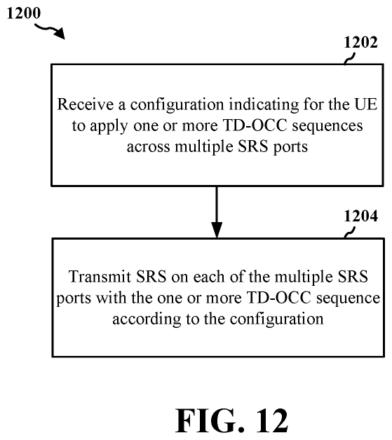

FIG. 12 is a flowchart 1200 of a method of wireless communication. The method may be performed by a UE (e.g., the UE 104, the UE 702; the apparatus 1904). The method may provide mechanisms for the UE and base station to determine a cyclic shift and/or comb offset based on whether SRS ports apply the same TD-OCC sequence or different TD-OCC sequences, such that overall efficiency or capacity may be increased.

At 1202, the UE may receive a configuration indicating for the UE to apply one or more TD-OCC sequences across multiple SRS ports. For example, the UE 702 may receive a configuration (e.g., 708) indicating for the UE to apply one or more TD-OCC sequences across multiple SRS ports. In some aspects, 1202 may be performed by TD-OCC component 198.

At 1204, the UE may transmit SRS on each of the multiple SRS ports with the one or more TD-OCC sequence according to the configuration. For example, the UE 702 may transmit SRS (e.g., 712) on each of the multiple SRS ports with the one or more TD-OCC sequence according to the configuration. In some aspects, 1204 may be performed by TD-OCC component 198.

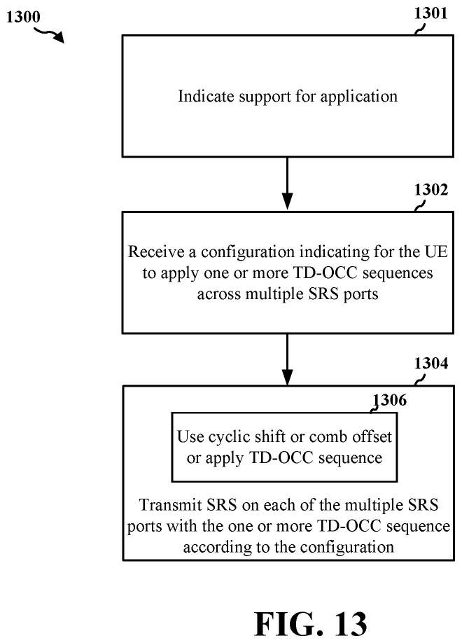

FIG. 13 is a flowchart 1300 of a method of wireless communication. The method may be performed by a UE (e.g., the UE 104, the UE 702; the apparatus 1904). The method may provide mechanisms for the UE and base station to determine a cyclic shift and/or comb offset based on whether SRS ports apply the same TD-OCC sequence or different TD-OCC sequences, such that overall efficiency or capacity may be increased.

At 1301, the UE may indicate support for application of at least one of a single TD-OCC sequence across the multiple SRS ports, multiple TD-OCC sequences across the multiple SRS ports, or a maximum number of different TD-OCC sequences across the multiple SRS ports. For example, the UE 702 may indicate (e.g., 706 support for application of at least one of a single TD-OCC sequence across the multiple SRS ports, multiple TD-OCC sequences across the multiple SRS ports, or a maximum number of different TD-OCC sequences across the multiple SRS ports. In some aspects, 1301 may be performed by TD-OCC component 198.

At 1302, the UE may receive a configuration indicating for the UE to apply one or more TD-OCC sequences across multiple SRS ports. For example, the UE 702 may receive a configuration (e.g., 708) indicating for the UE to apply one or more TD-OCC sequences across multiple SRS ports. In some aspects, 1302 may be performed by TD-OCC component 198. In some aspects, the multiple TD-OCC sequences include a first number of unique TD-OCC sequences to be applied over a second number of symbols to a third number of SRS ports, based on at least one of: the first number of the unique TD-OCC sequences being less than or equal to the third number of the SRS ports, the first number of the unique TD-OCC sequences being less than or equal to the second number of symbols, or a ratio of the third number of SRS ports to the first number of the unique TD-OCC sequences being an integer number. In some aspects, the configuration includes at least one of: a sequence configuration for each of multiple TD-OCC sequences, an index, from a defined set of sequences, for each of the multiple TD-OCC sequences, or a single index from the defined set of sequences, and a number of sequences.

At 1304, the UE may transmit SRS on each of the multiple SRS ports with the one or more TD-OCC sequence according to the configuration. For example, the UE 702 may transmit SRS (e.g., 712) on each of the multiple SRS ports with the one or more TD-OCC sequence according to the configuration. In some aspects, 1304 may be performed by TD-OCC component 198. As part of 1304, at 1306, the UE may use cyclic shift or comb offset or apply TD-OCC sequence. For example, the UE 702 may use cyclic shift or comb offset or apply TD-OCC sequence (e.g., at 710). In some aspects, 1306 may be performed by TD-OCC component 198. In some aspects, the configuration indicates for the UE to apply a single TD-OCC sequence across the multiple SRS ports and the UE may transmit the SRS on each of the multiple SRS ports using the single TD-OCC sequence. In some aspects, the configuration indicates for the UE to apply multiple TD-OCC sequences across the multiple SRS ports and the UE may transmit the SRS on different SRS ports using different TD-OCC sequences. In some aspects, the UE may use at least one of a different cyclic shift or a different comb offset for SRS transmissions using a same TD-OCC sequence across different SRS ports. In some aspects, the UE may use a same cyclic shift and a same comb offset for SRS transmissions using different TD-OCC sequences across the multiple SRS ports. In some aspects, the configuration indicates for the UE to apply a first number of TD-OCC sequences across a second number of SRS ports, and the UE may apply a same TD-OCC sequence among the first number of TD-OCC sequences for each SRS port within a group, the group being based on a set of consecutive port numbers or a set of port numbers sharing a same modulo based on the first number of the TD-OCC sequences. In some aspects, the UE may use a different cyclic shift and a same comb offset for SRS transmissions using the same TD-OCC sequence for the group that includes 2 SRS ports, use at least one of the different cyclic shift or a different comb offset for the SRS transmissions using the same TD-OCC sequence for the group that includes 4 SRS ports, or use a same cyclic shift and the same comb offset for corresponding SRS ports in each group. In some aspects, the configuration indicates for the UE to apply a first number of TD-OCC sequences across a second number of SRS ports, and the UE may apply a different TD-OCC sequence among the first number of TD-OCC sequences for each SRS port within a group, the group being based on a set of consecutive port numbers or a set of port numbers sharing a same modulo based on the first number of the TD-OCC sequences. In some aspects, the UE may use a same cyclic shift and a same comb offset for SRS transmissions from each SRS port in the group, use a different cyclic shift and the same comb offset for the SRS transmissions using the same TD-OCC sequence among 2 groups, or use at least one of the different cyclic shift or a different comb offset for the SRS transmissions using the same TD-OCC sequence among 4 groups.

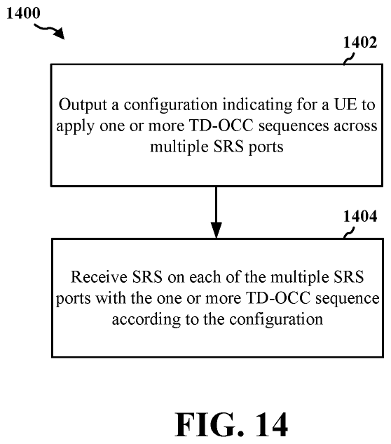

FIG. 14 is a flowchart 1400 of a method of wireless communication. The method may be performed by a network node (e.g., the base station 102, the network entity 704, the network entity 1902, the network entity 2002). The method may provide mechanisms for the UE and base station to determine a cyclic shift and/or comb offset based on whether SRS ports apply the same TD-OCC sequence or different TD-OCC sequences, such that overall efficiency or capacity may be increased.

At 1402, the network entity may output a configuration indicating for a UE to apply one or more TD-OCC sequences across multiple SRS ports. For example, the network entity 704 may output a configuration (e.g., 708) indicating for a UE to apply one or more TD-OCC sequences across multiple SRS ports. In some aspects, 1402 may be performed by TD-OCC component 199.

At 1404, the network entity may receive SRS on each of the multiple SRS ports with the one or more TD-OCC sequence according to the configuration. For example, the network entity 704 may receive SRS (e.g., 712) on each of the multiple SRS ports with the one or more TD-OCC sequence according to the configuration. In some aspects, 1404 may be performed by TD-OCC component 199.

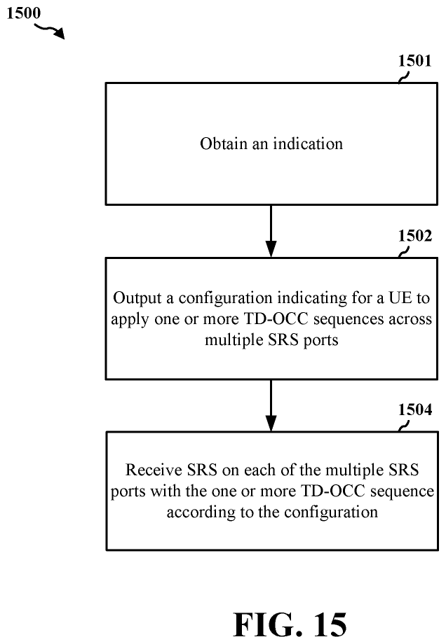

FIG. 15 is a flowchart 1500 of a method of wireless communication. The method may be performed by a network node (e.g., the base station 102, the network entity 704, the network entity 1902, the network entity 1402). The method may provide mechanisms for the UE and base station to determine a cyclic shift and/or comb offset based on whether SRS ports apply the same TD-OCC sequence or different TD-OCC sequences, such that overall efficiency or capacity may be increased.

At 1501, the network entity may obtain an indication that the UE supports an application of at least one of a single TD-OCC sequence across the multiple SRS ports, multiple TD-OCC sequences across the multiple SRS ports, or a maximum number of different TD-OCC sequences across the multiple SRS ports. For example, the network entity 704 may obtain an indication (e.g., 706) that the UE supports an application of at least one of a single TD-OCC sequence across the multiple SRS ports, multiple TD-OCC sequences across the multiple SRS ports, or a maximum number of different TD-OCC sequences across the multiple SRS ports. In some aspects, 1501 may be performed by TD-OCC component 199.

At 1502, the network entity may output a configuration indicating for a UE to apply one or more TD-OCC sequences across multiple SRS ports. For example, the network entity 704 may output a configuration (e.g., 708) indicating for a UE to apply one or more TD-OCC sequences across multiple SRS ports. In some aspects, 1502 may be performed by TD-OCC component 199. In some aspects, the configuration indicates for the UE to apply a single TD-OCC sequence across the multiple SRS ports, the SRS on each of the multiple SRS ports using the single TD-OCC sequence. In some aspects, the configuration indicates for the UE to apply multiple TD-OCC sequences across the multiple SRS ports, the SRS on different SRS ports using different TD-OCC sequences. In some aspects, the multiple TD-OCC sequences include a first number of unique TD-OCC sequences to be applied over a second number of symbols to a third number of SRS ports, based on at least one of: the first number of the unique TD-OCC sequences being less than or equal to the third number of the SRS ports, the first number of the unique TD-OCC sequences being less than or equal to the second number of symbols, or a radio of the number of SRS ports to the first number of the unique TD-OCC sequences being an integer number. In some aspects, the configuration includes at least one of: a sequence configuration for each of multiple TD-OCC sequences, an index, from a defined set of sequences, for each of the multiple TD-OCC sequences, or a single index from the defined set of sequences, and a number of sequences. In some aspects, the configuration indicates for the UE to apply a first number of TD-OCC sequences across a second number of SRS ports with a same TD-OCC sequence to be applied among the first number of TD-OCC sequences for each SRS port within a group, the group being based on: a set of consecutive port numbers, or a set of port numbers sharing a same modulo based on the first number of the TD-OCC sequences. In some aspects, the configuration indicates for the UE to apply a first number of TD-OCC sequences across a second number of SRS ports with a different TD-OCC sequence to be applied among the first number of TD-OCC sequences for each SRS port within a group, the group being based on a set of consecutive port numbers, or a set of port numbers sharing a same modulo based on the first number of the TD-OCC sequences.

At 1504, the network entity may receive SRS on each of the multiple SRS ports with the one or more TD-OCC sequence according to the configuration. For example, the network entity 704 may receive SRS (e.g., 712) on each of the multiple SRS ports with the one or more TD-OCC sequence according to the configuration. In some aspects, 1504 may be performed by TD-OCC component 199. In some aspects, the SRS on the multiple SRS ports include at least one of a different cyclic shift or a different comb offset for SRS transmissions using a same TD-OCC sequence across different SRS ports. In some aspects, the SRS on the multiple SRS ports include a same cyclic shift and a same comb offset for SRS transmissions using different TD-OCC sequences across the multiple SRS ports. In some aspects, the SRS includes at least one of a different cyclic shift and a same comb offset for SRS transmissions using the same TD-OCC sequence for the group that includes 2 SRS ports, at least one of the different cyclic shift or a different comb offset for the SRS transmissions using the same TD-OCC sequence for the group that includes 4 SRS ports, or a same cyclic shift and the same comb offset for corresponding SRS ports in each group. In some aspects, the SRS includes at least one of: a same cyclic shift and a same comb offset for SRS transmissions from each SRS port in the group, a different cyclic shift and the same comb offset for the SRS transmissions using the same TD-OCC sequence among 2 groups, or at least one of the different cyclic shift or a different comb offset for the SRS transmissions using the same TD-OCC sequence among 4 groups.

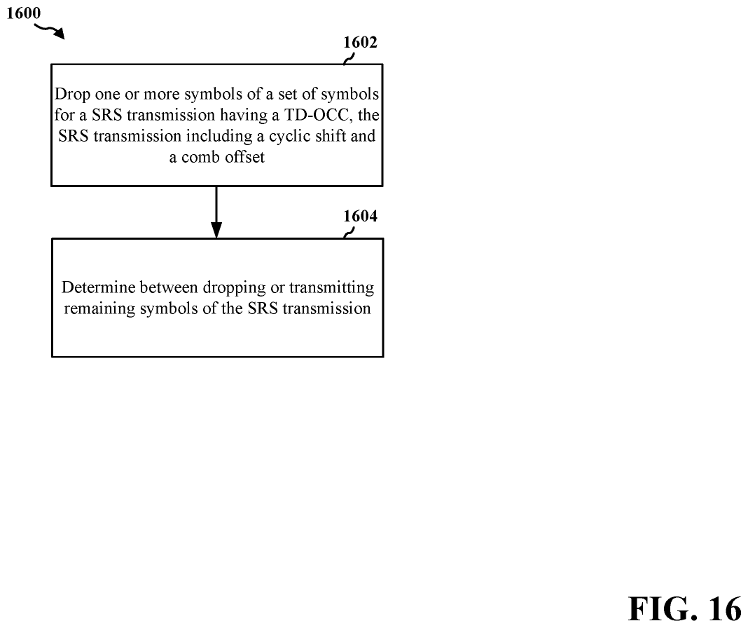

FIG. 16 is a flowchart 1600 of a method of wireless communication. The method may be performed by a UE (e.g., the UE 104, the UE 902, the UE 906; the apparatus 1904). The method may allow network with flexibility to control the behavior for different SRS resources or different UEs in various scenarios.

At 1602, the UE may drop one or more symbols of a set of symbols for an SRS transmission having a TD-OCC, the SRS transmission including a cyclic shift and a comb offset. For example, the UE 902 may drop (e.g., at 910) one or more symbols of a set of symbols for an SRS transmission (e.g., 914A) having a TD-OCC, the SRS transmission including a cyclic shift and a comb offset. In some aspects, 1602 may be performed by TD-OCC component 198.

At 1604, the UE may determine to drop or to transmit remaining symbols of the SRS transmission. For example, the UE 902 may determine (e.g., at 912) to drop or to transmit remaining symbols of the SRS transmission. In some aspects, 1604 may be performed by TD-OCC component 198.

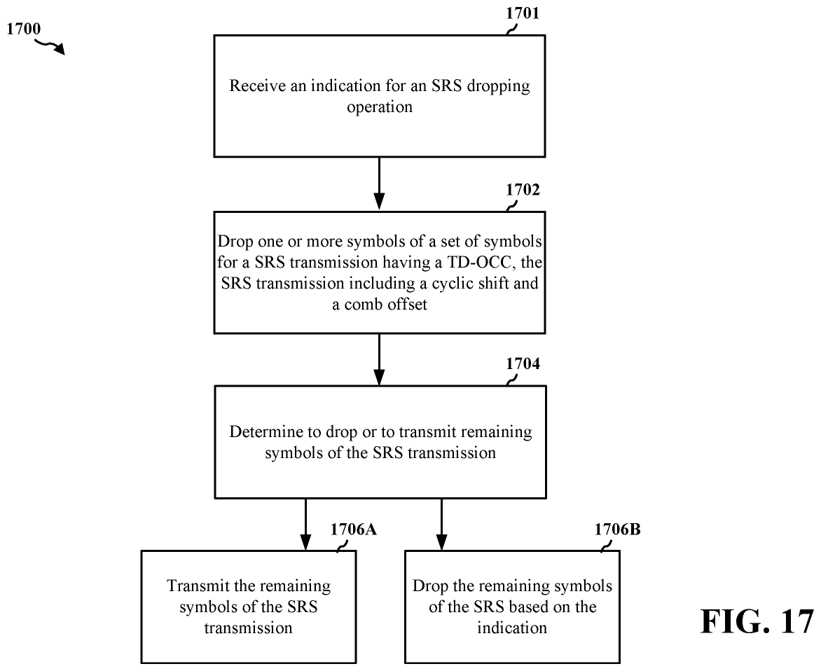

FIG. 17 is a flowchart 1700 of a method of wireless communication. The method may be performed by a UE (e.g., the UE 104, the UE 902, the UE 906; the apparatus 1904). The method may allow network with flexibility to control the behavior for different SRS resources or different UEs in various scenarios.

At 1701, the UE may receive an indication for an SRS dropping operation. For example, the UE 902 may receive an indication (e.g., 908A) for an SRS dropping operation. In some aspects, 1701 may be performed by TD-OCC component 198. In some aspects, the indication is included in a configuration for an SRS resource of the SRS transmission. In some aspects, the indication is included in at least one of DCI or MAC-CE.

At 1702, the UE may drop one or more symbols of a set of symbols for an SRS transmission having a TD-OCC, the SRS transmission including a cyclic shift and a comb offset. For example, the UE 902 may drop (e.g., at 910) one or more symbols of a set of symbols for an SRS transmission (e.g., 914A) having a TD-OCC, the SRS transmission including a cyclic shift and a comb offset. In some aspects, 1702 may be performed by TD-OCC component 198.

At 1704, the UE may determine to drop or to transmit remaining symbols of the SRS transmission. For example, the UE 902 may determine (e.g., at 912) to drop or to transmit remaining symbols of the SRS transmission. In some aspects, 1704 may be performed by TD-OCC component 198. In some aspects, the UE may determine to drop or transmit the remaining symbols of the SRS transmission based on the indication. In some aspects, the UE may determine to drop or to transmit the remaining symbols of the SRS transmission based at least in part on a priority of an SRS resource for the SRS transmission. In some aspects, the UE may determine to drop or to transmit the remaining symbols of the SRS transmission based at least in part on a reason for the dropping of the one or more symbols of the SRS transmission. In some aspects, the reason is one of an overlap in time with at least one of a SSB, a dynamically scheduled downlink signal or channel, an uplink channel having a higher priority than the SRS transmission, or a higher priority SRS transmission, an uplink cancellation indication (ULCI), or a conflict with a slot format indicator (SFI). In some aspects, the UE may determine to drop or to transmit the remaining symbols of the SRS transmission based at least in part on a use of the SRS transmission. In some aspects, the UE may determine to drop or to transmit the remaining symbols of the SRS transmission based on one or more of: an indication from a network node, a priority of an SRS resource for the SRS transmission, a reason for the dropping of the one or more symbols of the SRS transmission, or a use of the SRS transmission.

At 1706A, the UE may transmit the remaining symbols of the SRS transmission. For example, the UE 902 may transmit the remaining symbols (e.g., 914A) of the SRS transmission. In some aspects, 1706A may be performed by TD-OCC component 198. In some aspects, the UE may transmit the remaining symbols of the SRS transmission with the cyclic shift and the comb offset. In some aspects, the UE may transmit the remaining symbols of the SRS transmission with one or more changed parameter. In some aspects, the one or more changed parameter includes at least one of: skipping transmission on a subset of SRS ports for the remaining symbols, a different cyclic shift for the remaining symbols, a different comb offset for the remaining symbols, or skipping the TD-OCC for the remaining symbols.

At 1706B, the UE may drop the remaining symbols of the SRS based on the indication. For example, the UE 902 may drop the remaining symbols of the SRS (e.g., 914A) based on the indication. In some aspects, 1706B may be performed by TD-OCC component 198.

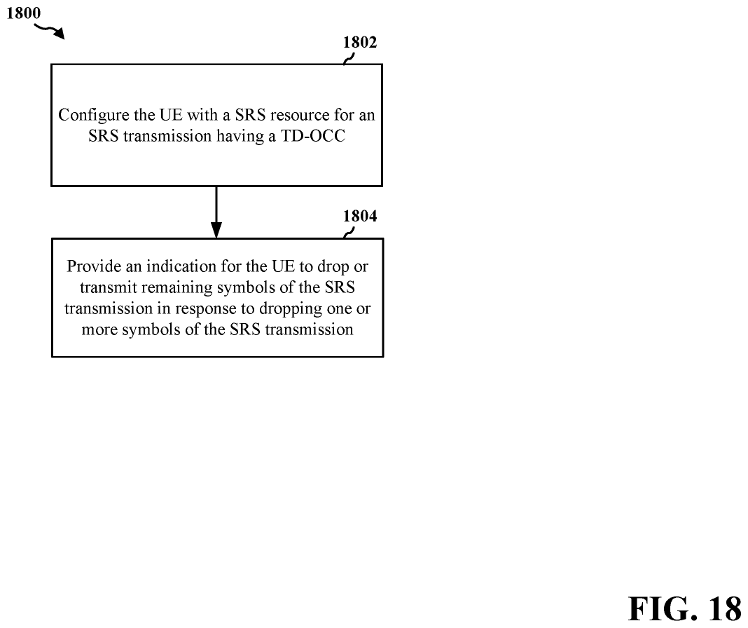

FIG. 18 is a flowchart 1800 of a method of wireless communication. The method may be performed by a network node (e.g., the base station 102, the network entity 904, the network entity 1902, the network entity 2002). The method may allow network with flexibility to control the behavior for different SRS resources or different UEs in various scenarios.

At 1802, the network node may configure a UE with an SRS resource for an SRS transmission having a TD-OCC. For example, the network entity 904 may configure the UE (e.g., UE 902 or UE 906) with an SRS resource (e.g., 907A or 907B) for an SRS transmission (e.g., 914A or 914B) having a TD-OCC. In some aspects, 1802 may be performed by TD-OCC component 199.

At 1804, the network node may provide an indication for the UE to drop or transmit remaining symbols of the SRS transmission in response to dropping one or more symbols of the SRS transmission. For example, the network entity 904 may provide an indication (e.g., 908A or 908B) for the UE to drop or transmit remaining symbols of the SRS transmission in response to dropping one or more symbols of the SRS transmission (e.g., at 910). In some aspects, 1804 may be performed by TD-OCC component 199. In some aspects, the indication indicates for the UE to perform one of: transmit the remaining symbols of the SRS transmission with a same cyclic shift and a same comb offset, transmit the remaining symbols of the SRS transmission with one or more changed parameter, or drop the remaining symbols of the SRS based on the indication. In some aspects, the one or more changed parameter includes at least one of: skipping transmission on a subset of SRS ports for the remaining symbols, a different cyclic shift for the remaining symbols, a different comb offset for the remaining symbols, or skipping the TD-OCC for the remaining symbols. In some aspects, the indication is included in a configuration for an SRS resource of the SRS transmission. In some aspects, the indication is included in at least one of DCI or a MAC-CE. In some aspects, the indication indicates for the UE to drop or transmit the remaining symbols of the SRS transmission based on one or more of: a priority of an SRS resource for the SRS transmission, a reason for the dropping of the one or more symbols of the SRS transmission, or a use of the SRS transmission.

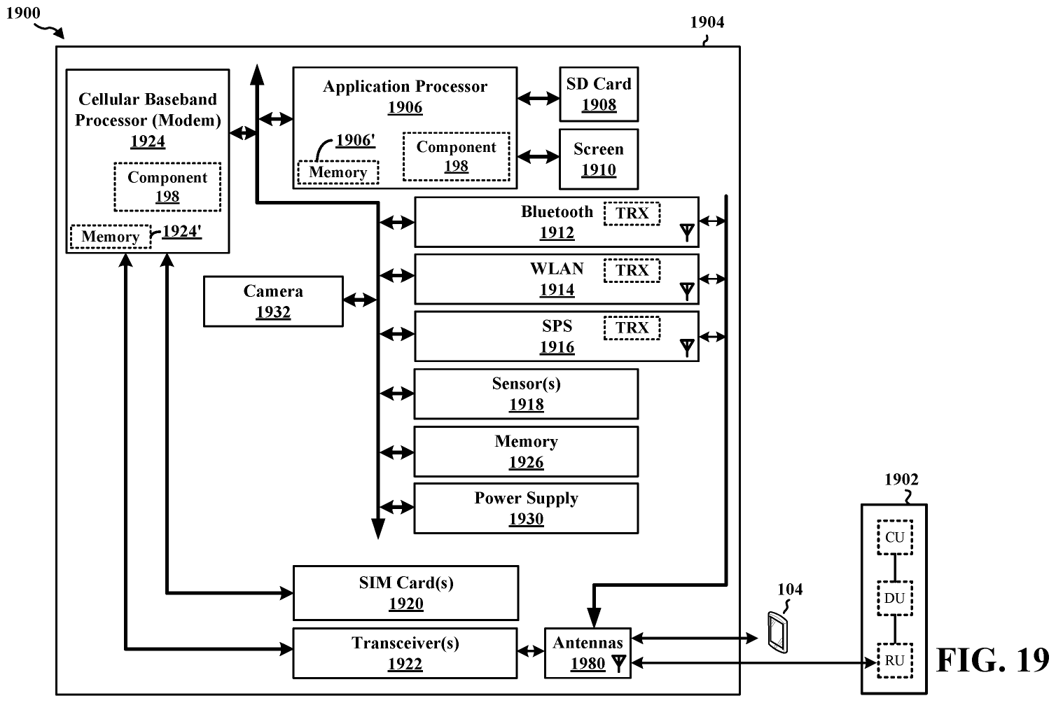

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX)/receiver (RX). In some aspects, the Bluetooth module, the WLAN module, and the SPS module may include their own dedicated antennas and/or may utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described herein. The cellular baseband processor(s) 1924 and the application processor(s) 1906 are configured to perform the various functions described supra based at least in part of the information stored in the memory. That is, the cellular baseband processor(s) 1924 and the application processor(s) 1906 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor 1924/application processor 1906 when executing software. The cellular baseband processor 1924/application processor 1906 may be a component of the UE 350 and may include the at least one memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed herein, the TD-OCC component 198 may be configured to receive a configuration indicating for the UE to apply one or more TD-OCC sequences across multiple SRS ports. In some aspects, the TD-OCC component 198 may be further configured to receive a configuration indicating for the UE to apply one or more TD-OCC sequences across multiple SRS ports. In some aspects, the TD-OCC component 198 may be configured to drop one or more symbols of a set of symbols for an SRS transmission having a TD-OCC, the SRS transmission including a cyclic shift and a comb offset. In some aspects, the TD-OCC component 198 may be further configured to determine to drop or transmit remaining symbols of the SRS transmission. The TD-OCC component 198 may be within the cellular baseband processor 1924, the application processor 1906, or both the cellular baseband processor 1924 and the application processor 1906. The TD-OCC component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1904 may include a variety of components configured for various functions. In one configuration, the apparatus 1904, and in particular the cellular baseband processor 1924 and/or the application processor 1906, includes means for receiving a configuration indicating for the UE to apply one or more TD-OCC sequences across multiple SRS ports. In some aspects, the apparatus 1904 may further include means for transmitting SRS on each of the multiple SRS ports with the one or more TD-OCC sequence according to the configuration. In some aspects, the apparatus 1904 may further include means for indicating support for application of at least one of a single TD-OCC sequence across the multiple SRS ports, multiple TD-OCC sequences across the multiple SRS ports, or a maximum number of different TD-OCC sequences across the multiple SRS ports. In some aspects, the apparatus 1904 may further include means for using at least one of a different cyclic shift or a different comb offset for SRS transmissions using a same TD-OCC sequence across different SRS ports. In some aspects, the apparatus 1904 may further include means for using a same cyclic shift and a same comb offset for SRS transmissions using different TD-OCC sequences across the multiple SRS ports. In some aspects, the apparatus 1904 may further include means for applying a same TD-OCC sequence among the first number of TD-OCC sequences for each SRS port within a group. In some aspects, the apparatus 1904 may further include means for using a different cyclic shift and a same comb offset for SRS transmissions using the same TD-OCC sequence for the group that includes 2 SRS ports. In some aspects, the apparatus 1904 may further include means for using at least one of the different cyclic shift or a different comb offset for the SRS transmissions using the same TD-OCC sequence for the group that includes 4 SRS ports. In some aspects, the apparatus 1904 may further include means for using a same cyclic shift and the same comb offset for corresponding SRS ports in each group. In some aspects, the apparatus 1904 may further include means for applying a different TD-OCC sequence among the first number of TD-OCC sequences for each SRS port within a group. In some aspects, the apparatus 1904 may further include means for using a same cyclic shift and a same comb offset for SRS transmissions from each SRS port in the group. In some aspects, the apparatus 1904 may further include means for using a different cyclic shift and the same comb offset for the SRS transmissions using the same TD-OCC sequence among 2 groups. In some aspects, the apparatus 1904 may further include means for using at least one of the different cyclic shift or a different comb offset for the SRS transmissions using the same TD-OCC sequence among 4 groups. In one configuration, the apparatus 1904, and in particular the cellular baseband processor 1924 and/or the application processor 1906, includes means for dropping one or more symbols of a set of symbols for an SRS transmission having a TD-OCC, the SRS transmission including a cyclic shift and a comb offset. In some aspects, the apparatus 1904 may further include means for determining between dropping or transmitting remaining symbols of the SRS transmission. In some aspects, the apparatus 1904 may further include means for transmitting the remaining symbols of the SRS transmission with the cyclic shift and the comb offset. In some aspects, the apparatus 1904 may further include means for transmitting the remaining symbols of the SRS transmission with one or more changed parameter. In some aspects, the apparatus 1904 may further include means for receiving an indication for an SRS dropping operation, where the UE determines between the dropping or the transmitting of the remaining symbols of the SRS transmission based on the indication. In some aspects, the apparatus 1904 may further include means for dropping the remaining symbols of the SRS based on the indication. In some aspects, the means for determining between the dropping and the transmitting of the remaining symbols of the SRS transmission is based at least in part on a priority of an SRS resource for the SRS transmission. In some aspects, the means for determining between the dropping and the transmitting of the remaining symbols of the SRS transmission is based at least in part on a reason for the dropping of the one or more symbols of the SRS transmission. In some aspects, the means for determining between the dropping and the transmitting of the remaining symbols of the SRS transmission is based at least in part on a use of the SRS transmission. In some aspects, the means for determining between the dropping and the transmitting of the remaining symbols of the SRS transmission is based on one or more of: an indication from a network node, a priority of an SRS resource for the SRS transmission, a reason for the dropping of the one or more symbols of the SRS transmission, or a use of the SRS transmission. The means may be the TD-OCC component 198 of the apparatus 1904 configured to perform the functions recited by the means. As described herein, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

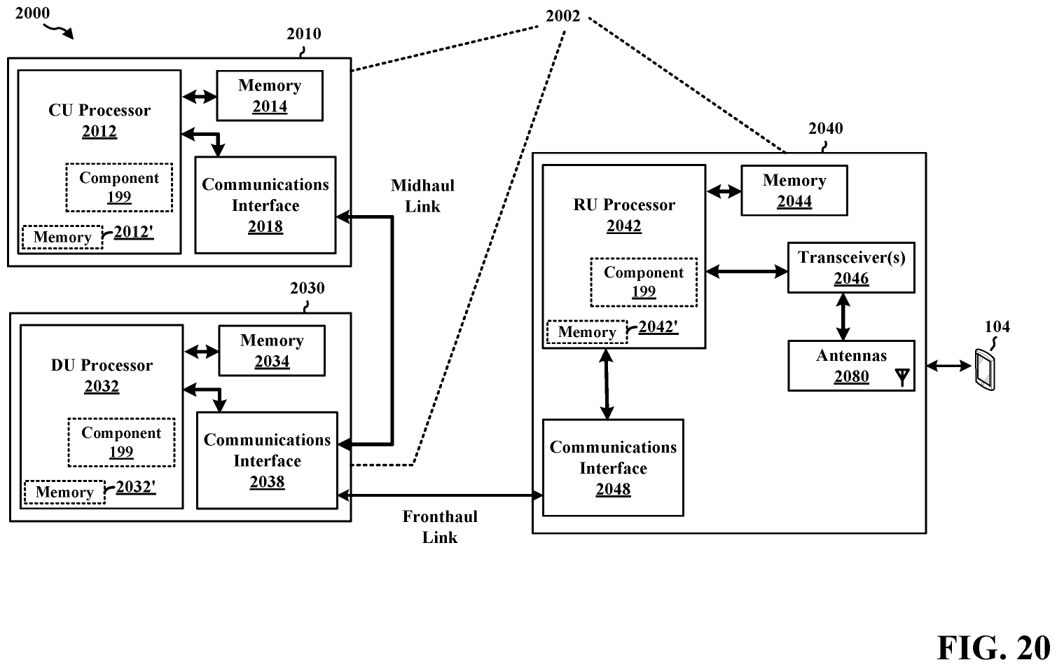

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the TD-OCC component 199 may be configured to output a configuration indicating for a UE to apply one or more TD-OCC sequences across multiple SRS ports. In some aspects, the TD-OCC component 199 may be further configured to receive SRS on each of the multiple SRS ports with the one or more TD-OCC sequence according to the configuration. The TD-OCC component 199 may be within one or more processors of one or more of the CU 2010, DU 2030, and the RU 2040. In some aspects, the TD-OCC component 199 may be configured to configure a UE with an SRS resource for an SRS transmission having a TD-OCC. In some aspects, the TD-OCC component 199 may be further configured to provide an indication for the UE to drop or transmit remaining symbols of the SRS transmission in response to dropping one or more symbols of the SRS transmission. The TD-OCC component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2002 may include a variety of components configured for various functions. In one configuration, the network entity 2002 includes means for outputting a configuration indicating for a UE to apply one or more TD-OCC sequences across multiple SRS ports. In some aspects, the network entity 2002 may further include means for receiving SRS on each of the multiple SRS ports with the one or more TD-OCC sequence according to the configuration. In some aspects, the network entity 2002 may further include means for obtaining an indication that the UE supports an application of at least one of a single TD-OCC sequence across the multiple SRS ports, multiple TD-OCC sequences across the multiple SRS ports, or a maximum number of different TD-OCC sequences across the multiple SRS ports. In one configuration, the network entity 2002 includes means for configuring a UE with an SRS resource for an SRS transmission having a TD-OCC. In some aspects, the network entity 2002 may further include means for providing an indication for the UE to drop or transmit remaining symbols of the SRS transmission in response to dropping one or more symbols of the SRS transmission. The means may be the TD-OCC component 199 of the network entity 2002 configured to perform the functions recited by the means. As described herein, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a configuration indicating for the UE to apply one or more TD-OCC sequences across multiple SRS ports; and transmitting SRS on each of the multiple SRS ports with the one or more TD-OCC sequence according to the configuration.

Aspect 2 is the method of aspect 1, where the configuration indicates for the UE to apply a single TD-OCC sequence across the multiple SRS ports, where the UE transmits the SRS on each of the multiple SRS ports using the single TD-OCC sequence.

Aspect 3 is the method of aspect 1, where the configuration indicates for the UE to apply multiple TD-OCC sequences across the multiple SRS ports, where the UE transmits the SRS on different SRS ports using different TD-OCC sequences.

Aspect 4 is the method of any of aspects 1-3, where the multiple TD-OCC sequences include a first number of unique TD-OCC sequences to be applied over a second number of symbols to a third number of SRS ports, based on at least one of: the first number of the unique TD-OCC sequences being less than or equal to the third number of the SRS ports, the first number of the unique TD-OCC sequences being less than or equal to the second number of symbols, or a ratio of the third number of SRS ports to the first number of the unique TD-OCC sequences being an integer number.

Aspect 5 is the method of any of aspects 1-4, further including: indicating support for application of at least one of: a single TD-OCC sequence across the multiple SRS ports, multiple TD-OCC sequences across the multiple SRS ports, or a maximum number of different TD-OCC sequences across the multiple SRS ports.

Aspect 6 is the method of any of aspects 1-5, where the configuration includes at least one of: a sequence configuration for each of multiple TD-OCC sequences, an index, from a defined set of sequences, for each of the multiple TD-OCC sequences, or a single index from the defined set of sequences, and a number of sequences.

Aspect 7 is the method of any of aspects 1-6, further including: using at least one of a different cyclic shift or a different comb offset for SRS transmissions using a same TD-OCC sequence across different SRS ports.

Aspect 8 is the method of any of aspects 1-7, further including: using a same cyclic shift and a same comb offset for SRS transmissions using different TD-OCC sequences across the multiple SRS ports.

Aspect 9 is the method of any of aspect 1-8, where the configuration indicates for the UE to apply a first number of TD-OCC sequences across a second number of SRS ports, the method further including: applying a same TD-OCC sequence among the first number of TD-OCC sequences for each SRS port within a group, the group being based on: a set of consecutive port numbers, or a set of port numbers sharing a same modulo based on the first number of the TD-OCC sequences.

Aspect 10 is the method of any of aspect 1-9, further including at least one of: using a different cyclic shift and a same comb offset for SRS transmissions using the same TD-OCC sequence for the group that includes 2 SRS ports, using at least one of the different cyclic shift or a different comb offset for the SRS transmissions using the same TD-OCC sequence for the group that includes 4 SRS ports, or using a same cyclic shift and the same comb offset for corresponding SRS ports in each group.

Aspect 11 is the method of any of aspect 1-10, where the configuration indicates for the UE to apply a first number of TD-OCC sequences across a second number of SRS ports, the method further including: applying a different TD-OCC sequence among the first number of TD-OCC sequences for each SRS port within a group, the group being based on: a set of consecutive port numbers, or a set of port numbers sharing a same modulo based on the first number of the TD-OCC sequences.

Aspect 12 is the method of any of aspect 1-11, further including at least one of: using a same cyclic shift and a same comb offset for SRS transmissions from each SRS port in the group, using a different cyclic shift and the same comb offset for the SRS transmissions using the same TD-OCC sequence among 2 groups, or using at least one of the different cyclic shift or a different comb offset for the SRS transmissions using the same TD-OCC sequence among 4 groups.

Aspect 13 is a method of wireless communication at a network node, including: outputting a configuration indicating for a UE to apply one or more TD-OCC sequences across multiple SRS ports; and receiving SRS on each of the multiple SRS ports with the one or more TD-OCC sequence according to the configuration.

Aspect 14 is the method of aspect 13, where the configuration indicates for the UE to apply a single TD-OCC sequence across the multiple SRS ports, the SRS on each of the multiple SRS ports using the single TD-OCC sequence.

Aspect 15 is the method of aspect 13, where the configuration indicates for the UE to apply multiple TD-OCC sequences across the multiple SRS ports, the SRS on different SRS ports using different TD-OCC sequences.

Aspect 16 is the method of aspect 15, where the multiple TD-OCC sequences include a first number of unique TD-OCC sequences to be applied over a second number of symbols to a third number of SRS ports, based on at least one of: the first number of the unique TD-OCC sequences being less than or equal to the third number of the SRS ports, the first number of the unique TD-OCC sequences being less than or equal to the second number of symbols, or a radio of the number of SRS ports to the first number of the unique TD-OCC sequences being an integer number.

Aspect 17 is the method of any of aspects 13-16, further including: obtaining an indication that the UE supports an application of at least one of: a single TD-OCC sequence across the multiple SRS ports, multiple TD-OCC sequences across the multiple SRS ports, or a maximum number of different TD-OCC sequences across the multiple SRS ports.

Aspect 18 is the method of any of aspects 13-17, where the configuration includes at least one of: a sequence configuration for each of multiple TD-OCC sequences, an index, from a defined set of sequences, for each of the multiple TD-OCC sequences, or a single index from the defined set of sequences, and a number of sequences.

Aspect 19 is the method of any of aspects 13-18, where the SRS on the multiple SRS ports include: at least one of a different cyclic shift or a different comb offset for SRS transmissions using a same TD-OCC sequence across different SRS ports.

Aspect 20 is the method of any of aspects 13-19, where the SRS on the multiple SRS ports include: a same cyclic shift and a same comb offset for SRS transmissions using different TD-OCC sequences across the multiple SRS ports.

Aspect 21 is the method of any of aspects 13-20, where the configuration indicates for the UE to apply a first number of TD-OCC sequences across a second number of SRS ports with a same TD-OCC sequence to be applied among the first number of TD-OCC sequences for each SRS port within a group, the group being based on: a set of consecutive port numbers, or a set of port numbers sharing a same modulo based on the first number of the TD-OCC sequences.

Aspect 22 is the method of any of aspects 13-21, where the SRS includes at least one of: a different cyclic shift and a same comb offset for SRS transmissions using the same TD-OCC sequence for the group that includes 2 SRS ports, at least one of the different cyclic shift or a different comb offset for the SRS transmissions using the same TD-OCC sequence for the group that includes 4 SRS ports, or a same cyclic shift and the same comb offset for corresponding SRS ports in each group.

Aspect 23 is the method of any of aspects 13-22, where the configuration indicates for the UE to apply a first number of TD-OCC sequences across a second number of SRS ports with a different TD-OCC sequence to be applied among the first number of TD-OCC sequences for each SRS port within a group, the group being based on: a set of consecutive port numbers, or a set of port numbers sharing a same modulo based on the first number of the TD-OCC sequences.

Aspect 24 is the method of any of aspects 13-23, where the SRS includes at least one of: a same cyclic shift and a same comb offset for SRS transmissions from each SRS port in the group, a different cyclic shift and the same comb offset for the SRS transmissions using the same TD-OCC sequence among 2 groups, or at least one of the different cyclic shift or a different comb offset for the SRS transmissions using the same TD-OCC sequence among 4 groups.

Aspect 25 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1 to 12.

Aspect 26 is an apparatus for wireless communication at a UE, comprising means for performing each step in the method of any of aspects 1 to 12.

Aspect 27 is the apparatus of any of aspects 25 to 26, further comprising a transceiver configured to receive or to transmit in association with the method of any of aspects 1 to 12.

Aspect 28 is a computer-readable medium storing computer executable code at a UE, the code when executed by at least one processor causes the at least one processor to perform the method of any of aspects 1 to 12.

Aspect 29 is a method of wireless communication at a UE, comprising: dropping one or more symbols of a set of symbols for a SRS transmission having a TD-OCC, the SRS transmission including a cyclic shift and a comb offset; and determining between dropping or transmitting remaining symbols of the SRS transmission.

Aspect 30 is the method of aspect 29, further comprising: transmitting the remaining symbols of the SRS transmission with the cyclic shift and the comb offset.

Aspect 31 is the method of any of aspects 29-30, further comprising: transmitting the remaining symbols of the SRS transmission with one or more changed parameter.

Aspect 32 is the method of any of aspects 29-31, wherein the one or more changed parameter includes at least one of: skipping transmission on a subset of SRS ports for the remaining symbols, a different cyclic shift for the remaining symbols, a different comb offset for the remaining symbols, or skipping the TD-OCC for the remaining symbols.

Aspect 33 is the method of any of aspects 29-34, further comprising: receiving an indication for an SRS dropping operation, wherein the UE determines between the dropping or the transmitting of the remaining symbols of the SRS transmission based on the configuration.

Aspect 34 is the method of any of aspects 29, and 31-33, further comprising: dropping the remaining symbols of the SRS based on the indication.

Aspect 35 is the method of any of aspects 29-34, wherein the indication is comprised in a configuration for an SRS resource of the SRS transmission.

Aspect 36 is the method of any of aspects 29-35, wherein the indication is comprised in at least one of DCI or a MAC-CE.

Aspect 37 is the method of any of aspects 29-36, wherein the determining between the dropping and the transmitting of the remaining symbols of the SRS transmission is based at least in part on a priority of an SRS resource for the SRS transmission.

Aspect 38 is the method of any of aspects 29-37, wherein the determining between the dropping and the transmitting of the remaining symbols of the SRS transmission is based at least in part on a reason for the dropping of the one or more symbols of the SRS transmission.

Aspect 39 is the method of any of aspects 29-38, wherein the reason is one of: an overlap in time with at least one of a SSB, a dynamically scheduled downlink signal or channel, an uplink channel having a higher priority than the SRS transmission, or a higher priority SRS transmission, an ULCI, or a conflict with a SFI.

Aspect 40 is the method of any of aspects 29-39, wherein the determining between the dropping and the transmitting of the remaining symbols of the SRS transmission is based at least in part on a use of the SRS transmission.

Aspect 41 is the method of any of aspects 29-40, wherein the determining between the dropping and the transmitting of the remaining symbols of the SRS transmission is based on one or more of: an indication from a network node, a priority of an SRS resource for the SRS transmission, a reason for the dropping of the one or more symbols of the SRS transmission, or a use of the SRS transmission.

Aspect 42 is a method of wireless communication at a network node, comprising: configuring the UE with a SRS resource for an SRS transmission having a TD-OCC; and providing an indication for the UE to drop or transmit remaining symbols of the SRS transmission in response to dropping one or more symbols of the SRS transmission.

Aspect 43 is the method of aspect 42, wherein the indication indicates for the UE to perform one of: transmit the remaining symbols of the SRS transmission with a same cyclic shift and a same comb offset, transmit the remaining symbols of the SRS transmission with one or more changed parameter, or drop the remaining symbols of the SRS based on the indication

Aspect 44 is the method of any of aspects 42-43, wherein the one or more changed parameter includes at least one of: skipping transmission on a subset of SRS ports for the remaining symbols, a different cyclic shift for the remaining symbols, a different comb offset for the remaining symbols, or skipping the TD-OCC for the remaining symbols.

Aspect 45 is the method of any of aspects 42-44, wherein the indication is comprised in a configuration for an SRS resource of the SRS transmission.

Aspect 46 is the method of any of aspects 42-45, wherein the indication is comprised in at least one of DCI or a MAC-CE.

Aspect 47 is the method of any of aspects 42-46, wherein the indication indicates for the UE to drop or transmit the remaining symbols of the SRS transmission based on one or more of: a priority of an SRS resource for the SRS transmission, a reason for the dropping of the one or more symbols of the SRS transmission, or a use of the SRS transmission.

Aspect 48 is an apparatus for wireless communication at a network node, comprising: at least one memory; and at least one processor coupled to the at least one memory and, based at least in part on information stored in the at least one memory, the at least one processor, individually or in any combination, is configured to perform the method of any of aspects 13 to 24 and 42 to 47.

Aspect 49 is an apparatus for wireless communication at a network node, comprising means for performing each step in the method of any of aspects 13 to 24 and 42 to 47.

Aspect 50 is the apparatus of any of aspects 48 to 49, further comprising a transceiver configured to receive or to transmit in association with the method of any of aspects 13 to 24 and 42 to 47.

Aspect 51 is a computer-readable medium storing computer executable code at a network node, the code when executed by at least one processor causes the at least one processor to perform the method of any of aspects 13 to 24 and 42 to 47.

Aspect 52 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1-12 and 29 to 41.

Aspect 53 is an apparatus for wireless communication at a UE, comprising means for performing each step in the method of any of aspects 1-12 and 29 to 41.

Aspect 54 is the apparatus of any of aspects 52 to 53, further comprising a transceiver configured to receive or to transmit in association with the method of any of aspects 1-12 and 29 to 41.

Aspect 55 is a computer-readable medium storing computer executable code at a UE, the code when executed by at least one processor causes the at least one processor to perform the method of any of aspects 1-12 and 29 to 41.

What is claimed is:

1. An apparatus for wireless communication at a user equipment (UE), comprising:
at least one memory; and
at least one processor coupled to the at least one memory and, based at least in part on information stored in the at least one memory, the at least one processor is, individually or in combination, configured to cause the apparatus to:
receive a configuration indicating for the UE to apply one or more time domain orthogonal cover code (TD-OCC) sequences across multiple sounding reference signal (SRS) ports; and
transmit SRS on each of the multiple SRS ports with the one or more TD-OCC sequence according to the configuration.

2. The apparatus of claim 1, wherein the configuration indicates for the UE to apply a single TD-OCC sequence across the multiple SRS ports, wherein the at least one processor is further configured to cause the apparatus to: transmit the SRS on each of the multiple SRS ports using the single TD-OCC sequence.

3. The apparatus of claim 1, wherein the configuration indicates for the UE to apply multiple TD-OCC sequences across the multiple SRS ports, wherein the at least one processor is further configured to cause the apparatus to: transmit the SRS on different SRS ports using different TD-OCC sequences.

4. The apparatus of claim 3, wherein the multiple TD-OCC sequences include a first number of unique TD-OCC sequences to be applied over a second number of symbols to a third number of SRS ports, based on at least one of:
the first number of the unique TD-OCC sequences being less than or equal to the third number of the SRS ports,
the first number of the unique TD-OCC sequences being less than or equal to the second number of symbols, or
a ratio of the third number of SRS ports to the first number of the unique TD-OCC sequences being an integer number.

5. The apparatus of claim 1, wherein the at least one processor is further configured to cause the apparatus to:
indicate support for application of at least one of:
a single TD-OCC sequence across the multiple SRS ports,
multiple TD-OCC sequences across the multiple SRS ports, or
a maximum number of different TD-OCC sequences across the multiple SRS ports.

6. The apparatus of claim 1, wherein the configuration includes at least one of:
a sequence configuration for each of multiple TD-OCC sequences,
an index, from a defined set of sequences, for each of the multiple TD-OCC sequences, or
a single index from the defined set of sequences, and a number of sequences.

7. The apparatus of claim 1, wherein the at least one processor is further configured to cause the apparatus to:
use at least one of a different cyclic shift or a different comb offset for SRS transmissions using a same TD-OCC sequence across different SRS ports.

8. The apparatus of claim 1, wherein the at least one processor is further configured to cause the apparatus to:
use a same cyclic shift and a same comb offset for SRS transmissions using different TD-OCC sequences across the multiple SRS ports.

9. The apparatus of claim 1, wherein the configuration indicates for the UE to apply a first number of TD-OCC sequences across a second number of SRS ports, wherein the at least one processor is further configured to cause the apparatus to:
apply a same TD-OCC sequence among the first number of TD-OCC sequences for each SRS port within a group, the group being based on:
a set of consecutive port numbers, or
a set of port numbers sharing a same modulo based on the first number of the TD-OCC sequences.

10. The apparatus of claim 9, wherein the at least one processor is further configured to cause the apparatus to:
use a different cyclic shift and a same comb offset for SRS transmissions using the same TD-OCC sequence for the group that includes 2 SRS ports,
use at least one of the different cyclic shift or a different comb offset for the SRS transmissions using the same TD-OCC sequence for the group that includes 4 SRS ports, or
use a same cyclic shift and the same comb offset for corresponding SRS ports in each group.

11. The apparatus of claim 1, wherein the configuration indicates for the UE to apply a first number of TD-OCC sequences across a second number of SRS ports, wherein the at least one processor is further configured to cause the apparatus to:
apply a different TD-OCC sequence among the first number of TD-OCC sequences for each SRS port within a group, the group being based on:
a set of consecutive port numbers, or
a set of port numbers sharing a same modulo based on the first number of the TD-OCC sequences.

12. The apparatus of claim 11, wherein the at least one processor is further configured to cause the apparatus to:
use a same cyclic shift and a same comb offset for SRS transmissions from each SRS port in the group,
use a different cyclic shift and the same comb offset for the SRS transmissions using the same TD-OCC sequence among 2 groups, or
use at least one of the different cyclic shift or a different comb offset for the SRS transmissions using the same TD-OCC sequence among 4 groups.

13. An apparatus for wireless communication at a network node, comprising:
at least one memory; and
at least one processor coupled to the at least one memory and, based at least in part on information stored in the at least one memory, the at least one processor is, individually or in combination, configured to cause the apparatus to:
output a configuration indicating for a user equipment (UE) to apply one or more time domain orthogonal cover code (TD-OCC) sequences across multiple sounding reference signal (SRS) ports; and
receive SRS on each of the multiple SRS ports with the one or more TD-OCC sequence according to the configuration.

14. The apparatus of claim 13, wherein the configuration indicates for the UE to apply a single TD-OCC sequence across the multiple SRS ports, the SRS on each of the multiple SRS ports using the single TD-OCC sequence.

15. The apparatus of claim 13, wherein the configuration indicates for the UE to apply multiple TD-OCC sequences across the multiple SRS ports, the SRS on different SRS ports using different TD-OCC sequences.

16. The apparatus of claim 13, wherein the multiple TD-OCC sequences include a first number of unique TD-OCC sequences to be applied over a second number of symbols to a third number of SRS ports, based on at least one of:
the first number of the unique TD-OCC sequences being less than or equal to the third number of the SRS ports,
the first number of the unique TD-OCC sequences being less than or equal to the second number of symbols, or
a radio of the number of SRS ports to the first number of the unique TD-OCC sequences being an integer number.

17. The apparatus of claim 13, wherein the at least one processor is further configured to cause the apparatus to:
obtain an indication that the UE supports an application of at least one of:
a single TD-OCC sequence across the multiple SRS ports,
multiple TD-OCC sequences across the multiple SRS ports, or
a maximum number of different TD-OCC sequences across the multiple SRS ports.

18. The apparatus of claim 13, wherein the configuration includes at least one of:
a sequence configuration for each of multiple TD-OCC sequences,
an index, from a defined set of sequences, for each of the multiple TD-OCC sequences, or
a single index from the defined set of sequences, and a number of sequences.

19. The apparatus of claim 13, wherein the SRS on the multiple SRS ports include:
at least one of a different cyclic shift or a different comb offset for SRS transmissions using a same TD-OCC sequence across different SRS ports.

20. The apparatus of claim 13, wherein the SRS on the multiple SRS ports include:
a same cyclic shift and a same comb offset for SRS transmissions using different TD-OCC sequences across the multiple SRS ports.

21. The apparatus of claim 13, wherein the configuration indicates for the UE to apply a first number of TD-OCC sequences across a second number of SRS ports with a same TD-OCC sequence to be applied among the first number of TD-OCC sequences for each SRS port within a group, the group being based on:
a set of consecutive port numbers, or
a set of port numbers sharing a same modulo based on the first number of the TD-OCC sequences.

22. The apparatus of claim 21, wherein the SRS includes at least one of:
a different cyclic shift and a same comb offset for SRS transmissions using the same TD-OCC sequence for the group that includes 2 SRS ports,
at least one of the different cyclic shift or a different comb offset for the SRS transmissions using the same TD-OCC sequence for the group that includes 4 SRS ports, or
a same cyclic shift and the same comb offset for corresponding SRS ports in each group.

23. The apparatus of claim 13, wherein the configuration indicates for the UE to apply a first number of TD-OCC sequences across a second number of SRS ports with a different TD-OCC sequence to be applied among the first number of TD-OCC sequences for each SRS port within a group, the group being based on:
a set of consecutive port numbers, or
a set of port numbers sharing a same modulo based on the first number of the TD-OCC sequences.

24. The apparatus of claim 23, wherein the SRS includes at least one of:
a same cyclic shift and a same comb offset for SRS transmissions from each SRS port in the group,
a different cyclic shift and the same comb offset for the SRS transmissions using the same TD-OCC sequence among 2 groups, or
at least one of the different cyclic shift or a different comb offset for the SRS transmissions using the same TD-OCC sequence among 4 groups.

25. An apparatus for wireless communication at a user equipment (UE), comprising:
at least one memory; and
at least one processor coupled to the at least one memory and, based at least in part on information stored in the at least one memory, the at least one processor is configured to cause the apparatus to:
drop one or more symbols of a set of symbols for a sounding reference signal (SRS) transmission having a time domain orthogonal cover code (TD-OCC), the SRS transmission including a cyclic shift and a comb offset; and
determine to drop or transmit remaining symbols of the SRS transmission.

26. The apparatus of claim 25, wherein the at least one processor is further configured to cause the apparatus to:
transmit the remaining symbols of the SRS transmission with the cyclic shift and the comb offset.

27. The apparatus of claim 25, wherein the at least one processor is further configured to cause the apparatus to:
transmit the remaining symbols of the SRS transmission with one or more changed parameter.

28. The apparatus of claim 27, wherein the one or more changed parameter includes at least one of:
skipping transmission on a subset of SRS ports for the remaining symbols,
a different cyclic shift for the remaining symbols,
a different comb offset for the remaining symbols, or
skipping the TD-OCC for the remaining symbols.

29. The apparatus of claim 25, wherein the at least one processor is further configured to cause the apparatus to:
receive an indication for an SRS dropping operation, wherein t the at least one processor is further configured to cause the apparatus to determine to drop or transmit the remaining symbols of the SRS transmission based on the indication.

30. An apparatus for wireless communication at a network node, comprising:
at least one memory; and
at least one processor coupled to the at least one memory and, based at least in part on information stored in the at least one memory, the at least one processor is configured to cause the apparatus to:
configure a user equipment (UE) with a sounding reference signal (SRS) resource for an SRS transmission having a time domain orthogonal cover code (TD-OCC); and
provide an indication for the UE to drop or transmit remaining symbols of the SRS transmission in response to dropping one or more symbols of the SRS transmission.
